(19) United States
(12) Patent Application Publication
(10) Pub. No.: US 2019/0148868 A1
(43) Pub. Date: May 16, 2019

(54) CONNECTOR CODING SYSTEM

(71) Applicant: Trolex Limited, Stockport (GB)

(72) Inventors: John Pierce-Jones, Stockport (GB); Kyle Hudson, Stockport (GB)

(21) Appl. No.: 16/179,209

(22) Filed: Nov. 2, 2018

(30) Foreign Application Priority Data
Nov. 3, 2017 (GB) 1718274.2

(51) Int. Cl. H01R 13/207; H01R 13/527; H01R 13/621; H01R 13/40

(52) U.S. Cl. CPC H01R 13/207; H01R 13/40; H01R 13/621; H01R 13/527

(57) ABSTRACT

A method of manufacturing a potted cartridge, the potted cartridge configured to be releasably attached to a connector housing to form a connector, the connector being for attachment to a second connector along an attachment axis. The method comprises connecting one or more cables to one or more contacts respectively, the one or more contacts being arranged within a main body of the potted cartridge, the main body comprising a cavity and the one or more cables extending through a portion of the cavity, and filing a portion of the cavity with a potting material so as to encapsulate a portion of the one or more cables.

### TECHNICAL FIELD

The present invention relates to a connector and has particular, but not exclusive, application to connectors which are suitable for use in environments where flammable or explosive materials may be present.

### BACKGROUND

In some environments, the use of conventional connectors such as simple plug and socket arrangements may pose a safety risk if the connectors are positioned in an environment within which explosive or flammable substances may be present (such as flammable gasses in mines, or fine powdered ingredients in food processing plants). For example, when disconnecting the connectors, a spark may jump between the connectors' respective contacts at the point of separation of the contacts, when they are almost but are not quite touching. This spark may ignite the explosive or flammable substance in the surrounding environment, causing a fire or an explosion. Connectors for use in such environments, commonly called ‘explosion proof connectors’, are therefore provided with safety features to prevent sparks and the like (or hot gas from a fire or explosion within the connector that has been ignited by such a spark) from coming into contact with the environment around the connector.

The above problem is particularly prevalent in relation to relatively high voltage connectors such as those through which the power supply runs to an electrical tool or machine. However, the problem also exists with respect to lower voltage electrical connectors, such as those through which electrical data signals are passed, (e.g. USB or Ethernet connectors). Although data connectors do not generally carry any significant risk of sparking, they are rarely certified as being intrinsically safe, meaning that in many jurisdictions the law nonetheless requires steps to be taken to prevent any potential spark from casing a fire or explosion.

Further, explosion proof connectors are being used increasingly for optical data connectors. Recent legislation has set out limits governing the amount of optical power that can be exposed in a hazardous area, so as to avoid the possibility of optical ignition/detonation of materials around the connectors. Accordingly, where the power that may be released by optical connectors exceeds this threshold then the connectors must include means to isolate that power (or a fire or explosion caused by that power) from the external environment.

Still further, even where connectors are certified as being intrinsically safe, meaning that there is zero risk of sparking or exposure of above-threshold optical power, connectors are often positioned at a boundary between a safe and an unsafe environment. For instance, one of a pair of connectors can often be found in an ‘Ex d’ explosion proof enclosure which is used to house electrical apparatus in potentially flammable or explosive environments. In such cases the connector must be capable of maintaining the integrity of the enclosure even if the connector itself is not deemed to present an ignition/detonation risk. For this reason, even intrinsically safe connectors often take the form of explosion proof connectors, since these connectors are sufficiently robust to maintain the integrity of the enclosure. In particular, a connector may be certified explosion proof when fitted to an existing Ex d enclosure.

A connector may be potted. For example, a connector installed at the boundary of an Ex d enclosure may be potted in order to help meet the relevant safety certification. A potted connector is assembled during manufacture and is then filed with a solid or gelatinous compound, such as a thermosetting polymer. The potting process freezes the connector in whatever configuration it was potted. The potted connector can then be installed, for example, at the boundary of an Ex d enclosure.

A pair of connectors may be coded (sometimes known as indexed). Coding (or indexing) refers to setting a connector with a code, such that only connectors with a corresponding matching code can connect with the connector to form a connector pair. Coding can be useful when many connectors are being used, particularly if the connectors themselves are otherwise identical.

A prior art connector is described in the applicant's earlier application, WO 2016/132094, which is hereby incorporated by reference.

It is one object of the present invention to mitigate or obviate disadvantages relating to connectors stated above or otherwise, and/or to provide an improved connector, and an improved manufacturing method relating to connectors.

### SUMMARY OF INVENTION

In a first aspect there is provided a method of manufacturing a potted cartridge, the potted cartridge configured to be releasably attached to a connector housing to form a connector, the connector being for attachment to a second connector along an attachment axis, the method comprising; connecting one or more cables to one or more contacts respectively, the one or more contacts being arranged within a main body of the potted cartridge, the main body comprising a cavity and the one or more cables extending through a portion of the cavity; filing a portion of the cavity with a potting material so as to encapsulate a portion of the one or more cables.

Potting a connector has many benefits, such as providing or helping to provide hermetic sealing of the connector, preventing moisture or corrosive agents getting into the connector, and providing resistance to shock and vibration. Additionally, in order for a connector to be certified for certain uses, the connector may need to meet certain standards. Potting may be used to help meet these standards. For example, some certification bodies or standards may require a connector to be able to withstand a particular force or pressure.

However potting the entire connector during manufacture according to prior art methods freezes the connector in a single configuration. As such, a user must specify certain features of the connector prior to potting, such as, for example, how they would like the connector to be coded. Coding (sometimes known as indexing) relates to setting a connector with a code, such that only connectors with a corresponding code can connect. Setting a coding prior to potting results in the coding being unchangeable, since the connector is frozen in the configuration in which it was potted.

Potting a cartridge which is configured to be releasably attached to a connector housing to form the connector, does not freeze the connector in a single configuration. For example, a user can remove the potted cartridge from the connector housing and install the potted cartridge in another connector housing. Additionally, a user may change the coding of the connector, using, for example a coding mechanism described below. As such, a user does not need to specify the coding they require prior to manufacture of the potted cartridge. Furthermore, as coding is not set during manufacture, each potted cartridge can be manufactured identically (depending only on the socket arrangement) and so the manufacturing process is speeded up. Further still, since the potted cartridges are identical, the potted cartridges may be stockpiled.

A further advantage to potting a cartridge rather than the entire connector is that the cartridge may be manufactured without having to twist the cable during coding. In prior art methods, coding is set by rotating an electrical insert which contains the contacts to a particular orientation. However, this is typically done after cables have been connected to the contacts, resulting in the cables of the contacts becoming twisted about the attachment axis which can result in damage of the cables. However, by potting only the cartridge, coding of the connector can be set after potting, such as when the cartridge is installed within a connector. Therefore, the cables can be potted while they are substantially parallel to one another.

The connector housing may provide mechanical features to allow the connector to attach to said second connector. For example, the connector housing may comprise guideways or lugs as described in more detail below.

The term “releasably attached” is used to mean that a component can be attached or fixed to another component by a user or a process, but can then subsequently be detached by the user or the process. For example, screws, or nuts and bolts may be used to releasably attach the potted cartridge to the connector housing to form the connector.

The contact may comprise a male or female contact, e.g. may be a plug or socket. The contact may be an electrical contact. The contact may be an optical contact. The cable may be suitable for transmitting a signal. For example, the cable may be a metal wire, or an optical cable.

The method may further comprise forming the main body. For example, the main body may be formed by a machining or casting process. Alternatively, the main body may be obtained by any other means.

The portion of the cavity filled may be the entire cavity, or may only be a portion of the cavity such that, when attached to the connector housing, a relevant certification requirement is met. For example, if the relevant certification requirement requires the connector to withstand a particular pressure, the amount of potting material used may be an amount which provides a connector which meets the relevant certification requirement.

The potting material may be used to seal any apertures which are not designed to be flame paths. For example, the potting material may provide a seal around the pins and sockets of the main body.

The method may further comprise forming, on the main body, a connection means configure to facilitate releasable attachment to the connector housing.

For example, the connection means may be one or more holes configured to receive one or more screws respectively, the screws configured to screw into the connector housing. Alternatively, the connection means may be one or more holes, each having screw threads which are configured to receive screws attached to, or passing through, the connector housing. The one or more holes may be formed in a backing ring of the main body. The connection means may be a surface of the main body which is suitable for being clamped by the connector housing.

In a second aspect of the invention there is described a method of manufacturing a connector, the method comprising releasably attaching a potted cartridge as provided in the first aspect to a connector housing to form a connector.

For example, the potted cartridge may be releasably attached to the connector housing using one or more screws or nuts and bolts.

The method may further comprise forming, on the connector housing, a connection means configure to facilitate releasable attachment to the potted cartridge.

The connection means of the connector housing may cooperate with the connection means of the potted cartridge. For example, the connection means of the potted cartridge may be one or more holes, and the connection means of the connector housing may also be one or more holes, where the sets of holes are arranged so as to line up and allow one or more screws to be inserted in the holes. The one or more holes may define threads for receipt of said screws.

The connector housing may be an attachment portion as described below.

The method may further comprise attaching a coding mechanism to the connector, the coding mechanism configured to allow connection of two connectors having corresponding coding and prevent connection of two connectors having non-corresponding coding, a portion of the coding mechanism configured to be moveable relative to the one or more contacts so as to set a coding of the connector prior to connection to said second connector.

For example, the coding mechanism may comprise a first portion comprising an first interlocking feature configured to interlock with a first interlocking feature on a corresponding first portion of said second connector, and a second portion comprising a second interlocking feature configured to interlock with a second interlocking feature on a corresponding second portion of said second connector, wherein the first portion of the coding mechanism is configured to be moveable relative to the contact.

The portion of the coding mechanism may comprise a collar.

The collar may be further rotatable relative to a second portion of the coding mechanism so as to set the coding of the connector prior to connection to said second connector, where the second portion is rotationally fixed relative to the contact.

The method may further comprise attaching the collar between the potted cartridge and the connector housing.

Attaching the collar between the potted cartridge and the connector housing may comprise clamping the collar between the potted cartridge and the connector housing.

The method may further comprise forming an attachment means on the connector housing, the attachment means configured to facilitate attachment to said second connector.

The attachment means may be one or more lugs configured to enter one or more guideways of the second connector, or may be one or more guideways configured to receive one or more lugs of the second connector, as described below.

In a third aspect there is proved a potted cartridge obtained by the method of the first aspect.

In a fourth aspect there is provided a connector obtained by the method of the second aspect.

In a fifth aspect there is provided a potted cartridge for installation within a connector housing to form a connector, the connector being for attachment to a second connector along an attachment axis, the potted cartridge comprising; a main body comprising an cavity; one or more contacts arranged within the main body and configured to connect to one or more second contacts on said second connector; one or more cables arranged within the cavity and connected to the one or more contacts; a potting material arranged within the cavity of the main body; wherein the potted cartridge is configured to be releasably attached to said connector housing.

The potting material may be a resin.

In a sixth aspect there is provided a connector comprising a potted cartridge as provided in the fifth aspect and a connector housing, wherein the connector housing comprises attachment means, the attachment means configured to facilitate attachment to said second connector.

In a seventh aspect there is provided a connector for attachment to a second connector along an attachment axis, the connector comprising; a main body comprising a contact configured to connect to a second contact on said second connector; a coding mechanism, the coding mechanism configured to allow connection of two connectors having corresponding coding and prevent connection of two connectors having non-corresponding coding, a portion of the coding mechanism configured to be moveable relative to the contact so as to set a coding of the connector prior to connection to said second connector.

Providing a connector having a coding mechanism as described, a coding can be set by moving the relevant portion of the coding mechanism without moving the contact, such as rotating the contact. As such, cables connected to the contact are not subject to unnecessary stress when setting a coding for the connector.

The main body may comprise an insert which comprises the contact.

The coding mechanism may comprise a first portion comprising an first interlocking feature configured to interlock with a first interlocking feature on a corresponding first portion of said second connector; and a second portion comprising a second interlocking feature configured to interlock with a second interlocking feature on a corresponding second portion of said second connector, wherein the first portion of the coding mechanism is configured to be moveable relative to the contact.

For example, for two connectors to be able to connect, the interlocking features of each portion must be correctly aligned such that they can interlock when brought together. If they are not all aligned, the connectors are prevented from connecting due to abutment of the interlocking features.

The interlocking features may comprise an extended portion and a recessed portion, the extend portion configured to enter a recessed portion of the corresponding interlocking feature, and the recessed portion configured to receive an extended portion of the corresponding interlocking feature.

The first portion may comprise a collar, the collar comprising the first interlocking feature.

The interlocking feature of the collar may have a rotational symmetry of order one about the attachment axis.

The collar may be rotatable relative to the contact and the second portion so as to set the coding of the connector prior to connection to said second connector.

For example, the collar may be rotatable about the attachment axis independent of the contact and the attachment portion. This may be achieved by providing the collar as a separate component from the main body and attachment means, e.g. not integrally formed with the main body or with the attachment means.

The collar may be configured to be clamped between the main body and an attachment portion of the connector.

The attachment portion may comprise lugs and/or guideways to facilitate connection to another connector as described below.

The collar may be rotated prior to being clamped in place between the main body and an attachment portion of the connector. When clamped in place, the collar may be prevented from further rotation.

The second portion may be rotationally fixed relative to the contact.

The second portion may have a rotational symmetry of order one about the attachment axis.

The second portion may comprise a recess configured to receive a tooth of said second connector, or a tooth configured to enter a recess of said second connector.

In an eighth aspect there is provided a connector for attachment to a second connector along an attachment axis, the connector comprising; a contact configured to connect to a second contact on the second connector; an attachment portion comprising a plurality of attachment means arranged on the attachment portion, the attachment means arranged to cooperate with attachment means on the second connector so as to attach the connector with the second connector; wherein a relationship between the attachment means is such that the connector has a rotational symmetry about the attachment axis of order one.

Advantageously, by providing said relationship between the attachment means, the connector may only be connected to the second connector in one relative orientation. This may be desirable in cases where, for example, a connector has an arrangement of electrical contact pins/sockets which must be correctly orientated in order to mate.

Alternatively, the relationship may be that one of the guideway/lug pairs have a larger cross section than the other two pairs. Such an arrangement would also lead to a rotational symmetry of order one.

The relationship may be an angular relationship.

For example, the angular relationship may be with respect to the attachment axis. Each of the attachment means may be separated by a predetermined angle from one another, with one of the attachment means having a different angular relationship to the rest of the other attachment means.

The relationship may comprise one of the attachment means being offset from a position which would provide an even distribution of attachment means.

That is, one or more of the attachment means are arranged in an even distribution, with at least one of the attachment means offset from a position which provides an even distribution. For example, consider first, second and third attachment means arranged circumferentially around cylinder. An even distribution would be one in which the attachment means are separated by 120 degrees. The third attachment means is offset from the even position, such that the first and second attachment means are still in the evenly distributed position, separated by 120 degrees, but the third attachment means is now closer than 120 degrees to the first attachment means and further than 120 degrees from the second attachment means.

The offset may be equal to or less than about 6 degrees.

Advantageously, by having a relatively small offset a rotational symmetry of order one is provided but also any reduction in robustness of the connection due to the uneven arrangement of attachment means is minimised. In some cases the offset may be less that about 6 degrees. In other cases, the offset may be equal to or less than about 3 degrees.

The attachment means may be circumferentially arranged about the connector.

The attachment means may comprise guideways configured to receive lugs of said second connector, or lugs arranged to mate with guideways of said second connector.

The guideways may comprise an axial and a transverse portion, and where the attachment portion further comprising a rotatable sleeve which can be rotated about the attachment axis, wherein one of the guideways or lugs are formed on the rotatable sleeve.

The connector may further comprise a limiting means which limits the angle through which the rotatable sleeve can be rotated.

The limiting means may be provided by a guideway and lug arrangement, where a lug of the sleeve extends into a circumferential guideway in the connector, where the circumferential guideway extends over a limited portion of the surface of the connector, thus limiting the range of angular rotation.

The sleeve may be limited to a rotational range of equal to, or less than, about 90 degrees. In another embodiment, the sleeve may be limited to a rotational range of equal to, or less than, about 45 degrees.

Any components of any of the aspects described above may comprise components which have been obtained through 3D printing. For example, an insert which comprises pins or sockets may be obtained by 3D printing.

In a ninth aspect, there is provided a method of manufacturing a connector for attachment to a second connector along an attachment axis, the method comprising forming a component of the connector using 3D printing; and attaching the component to a second component of the connector.

The connector may be of the type used in an Ex d environment.

Advantageously, the ninth aspect provides a method which allows parts, such as low volume parts, to be made without having to use traditional methods, such as casting, where a mould would need to be created for the part. This is particularly advantageous when making custom parts, since custom parts, once made, might not need to be made again and the mould will no longer be of use.

The second component of the connector may be manufactured using a casting method such that the connector contains a mix of one or more 3D printed components and one or more cast components.

The component may be an insert arranged to hold sockets or pins. 3D printing an insert allows for an efficient way to customise a pin and socket layout for example.

Forming the component of the connector using 3D printing may comprise preparing program instructions configured to cause a 3D printer to produce the component; executing the program instructions on a 3D printer to cause a 3D printer to produce the component;

In a tenth aspect there is provided a non-transitory computer readable medium containing program instructions for a 3D printer to produce a component according to the ninth aspect.

Any of the connectors of any of the aspects provided above may be of the type used in an Ex d environment.

Optional features of one aspect may be combined with optional features of another aspect.

### BRIEF DESCRIPTION OF FIGURES

Specific embodiments of the present invention will now be described with reference to the accompanying drawings, in which:

FIG. 1 is a cross-sectional side view of a pair of connectors, with the connectors in a connected configuration;

FIG. 2 is a cross-sectional side view of a pair of connectors, with the connectors in a configuration in which their respective contacts are close to one another;

FIG. 3 is a plan view of a pair of connectors, separated from each other;

FIG. 4 is a perspective view of one of the connectors;

FIG. 5A is a cross-sectional side view of the front portions of the connectors in the configuration shown in FIG. 1;

FIG. 5B is a top view of a guideway of one of the connectors, showing the position of a lug of the other connector when the connectors are in the configuration shown in FIG. 1;

FIG. 6A is a cross-sectional side view of the front portions of the connectors in a configuration in which their respective contacts are spaced apart from one another;

FIG. 6B is a top view of a guideway of one of the connectors, showing the position of a lug of the other connector when the connectors are in the configuration shown in FIG. 6A;

FIG. 7A is a cross-sectional side view of the front portions of the connectors in a configuration from which the connectors can be detached from one another;

FIG. 7B is a top view of a guideway of one of the connectors, showing the position of a lug of the other connector when the connectors are in the configuration shown in FIG. 7A;

FIG. 8 is an exaggerated schematic plan view of the guideway of one of the connectors;

FIG. 9A is a cross-sectional side view of the front portions of the connectors in a configuration in which they are secured with their respective contacts touching;

FIG. 9B is a top view of a guideway of one of the connectors, showing the position of a lug of the other connector when the connectors are in the configuration shown in FIG. 9A;

FIG. 10 is a perspective view of the connectors;

FIG. 11 is a perspective view of a second pair of connectors;

FIG. 12 is an exaggerated schematic plan view of the guideway of one of the connectors of FIG. 11;

FIG. 13 is a schematic illustration of a third pair of connectors;

FIG. 14 is a schematic illustration of a fourth pair of connectors;

FIG. 15 is a side view of a portion of a connector showing guideways according to an embodiment of the invention;

FIG. 16 is a schematic illustration of an end view of a connector showing the angular arrangement of the guideways of FIG. 15;

FIG. 17 is a side view of two connectors according to an embodiment of the invention in a detached state;

FIG. 18 is a side view of the two connectors shown in FIG. 17 in a semi-connected state;

FIG. 19 is a side view of the two connectors shown in FIG. 17 in a connected state;

FIG. 20 is a perspective view of a connector according to an embodiment of the invention;

FIG. 21 is a perspective view of a connector according to an embodiment of the invention;

FIG. 22 is a side view of a coding collar arranged about an insert of a connector according to an embodiment of the invention;

FIG. 23 is a perspective view of two coding collars mating;

FIG. 24 is a perspective view of two coding collars being prevented from mating;

FIG. 25 is a side view of a potted cartridge, coding collar and connector housing in a disassembled state;

FIG. 26 is a side view of the potted cartridge, coding collar and connector housing of FIG. 25 in an assembled state;

FIG. 27 is a perspective view of a potted cartridge with a coding collar;

FIG. 28 is a perspective view of a potted cartridge with a coding collar;

FIG. 29 is a perspective view of a connector comprising the potted cartridge of FIG. 27 with the guideways of the connector of FIG. 15;

FIG. 30 is a perspective view of a connector comprising the potted cartridge of FIG. 27 with the guideways of the connector of FIG. 15; and

FIG. 31 is a method of manufacturing a potted cartridge and a connector.

### DETAILED DESCRIPTION

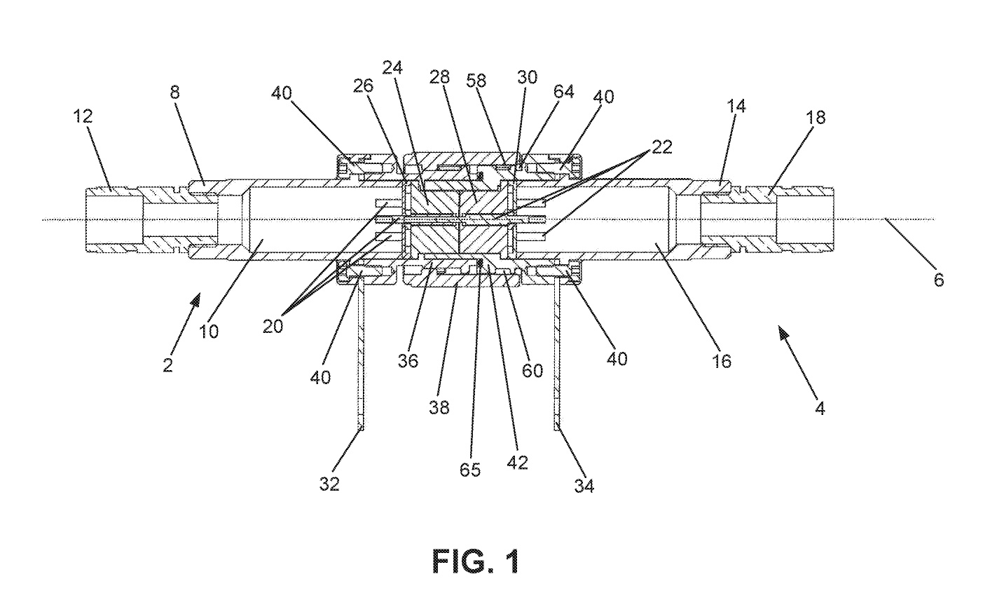

FIGS. 1 to 14 describe a connector as described in WO 2016/132094, features of which can be used with aspects of the present invention.

FIG. 1 shows a pair of connectors. The pair of connectors comprises a first connector 2 and a second connector 4 for attachment to one another along an attachment axis 6. FIG. 1 shows the connectors 2, 4 attached to one another. Although each connector 2, 4 of FIG. 1 is elongate and extends along the attachment axis 6 (when the connectors are attached together), in other embodiments this may not be the case. For example, one or both of the connectors may not be elongate, or may be elongate but not aligned with the attachment axis.

The first connector 2 has a main body 8 which defines a cavity 10 for the receipt of an end of an electrical cable (not shown). The first connector 2 and the electrical cable (not shown) can be attached together using a cable gland 12 in conventional fashion. When the connector 2 is attached to an electrical cable (not visible), the cable gland 12 sealingly engages with the cable about the circumferential periphery of the cable, and also sealingly engages with the main body 8 of the first connector 2. The rear end of the cavity 10 (i.e. the end of the cavity which is furthest from the second connector 4 along the attachment axis 6) is therefore sealed closed.

In a similar fashion to the first connector 2, the second connector also has a main body 14 which defines a cavity 16 for receipt of an end of an electrical cable (not shown). Again, the electrical cable (not shown) and the second connector 4 can be attached to one another in known fashion using a cable gland 18, sealing closed the rear end of the cavity 16 (i.e. the end of the cavity which is furthest from the first connector 2 along the attachment axis 6).

It will be apparent from FIG. 1 that in this particular example, the main bodies 8, 14 of the first and second connectors 2, 4 are substantially identical. This can reduce the manufacturing costs by reducing the number of different parts which are required to produce a pair of connectors, and by providing greater economies of scale. For the same reason, in this example the cable glands 12, 18 are also substantially identical. In other examples, however, where appropriate the main bodies of the first and second connectors, and/or the cable glands for attachment to the first and second connectors, may differ from one another.

The first connector 2 has a plurality of electrical contacts 20, each of which projects into the cavity 10 for connection to an individual wire (not visible) of an electrical cable to which the first connector 2 is attached. Similarly, the second connector 4 has a set of electrical contacts 22 which project into the cavity 16 for attachment to wires of an electrical cable (not visible).

In this case the contacts 20 of the first connector 2 are female contacts and the contacts 22 of the second connector 4 are male contacts. However, it will be readily apparent to the skilled person that any other suitable arrangement may be used. For instance, the first connector 2 may have male contacts and the second connector 4, female contacts, each of the connectors 2, 4 may have a mixture of male and female contacts. Furthermore, although in this example the contacts 20, 22 are of a conventional design, other examples may use contacts of any other suitable type and/or configuration (for instance contacts which each have a male portion and a female portion, or contacts which are neither male nor female and which merely abut with one another).

The contacts 20 of the first connector 2 are held in respective bores in an electrically insulating insert 24 and an electrically insulating cover plate 26. Similarly, the contacts 22 of the second connector 4 are held in respective bores in an insulating insert 28 and cover plate 30. The inserts 24, 28 and the cover plates 26, 30 are also substantially identical to one another, although it will be appreciated that this need not be the case. The inserts 24, 28 and cover plates 26, 30 space apart their respective sets of contacts 20, 22, preventing a short circuit (or excessive creepage), and also hold the contacts securely within their respective connectors 2, 4. As shown in FIG. 1, the female contacts 20 are recessed within the insert 24, and the male contacts 22 project from the insert 28. With the connectors 2, 4 attached together in the manner shown in FIG. 1, the male contacts 22 are received within corresponding female contacts 20, providing an electrical connection therebetween and allowing an electrical data signal or electrical current to pass between cables (not shown) attached to the connectors.

The front of the cavity 10 (i.e. the end of the cavity nearest to the second connector 4 along the attachment axis) and/or the front of the cavity 16 may be sealed closed, for instance by the associated insert 24, 28 or cover plate 26, 30. However, in this example there are close tolerances between the components in front of each cavity 10, 16 but no seal is formed.

The first and second connectors 2, 4 are provided with respective handles 32, 34 by which they can be moved together or apart, and respective attachment portions 36, 38 for attaching the connectors to one another. In this particular embodiment the attachment portion 36 of the first connector 2 is attached directly to the main body 8 (in this case by screws 40), whereas the attachment portion 38 of the second connector 4 is attached indirectly to the main body 14. More specifically, the attachment portion 38 of the second connector 4 is attached to a support portion 42, and the support portion is attached to the main body 14 (also using screws 40 in this case). The structure and function of the attachment portions 36, 38 will be described in more detail below.

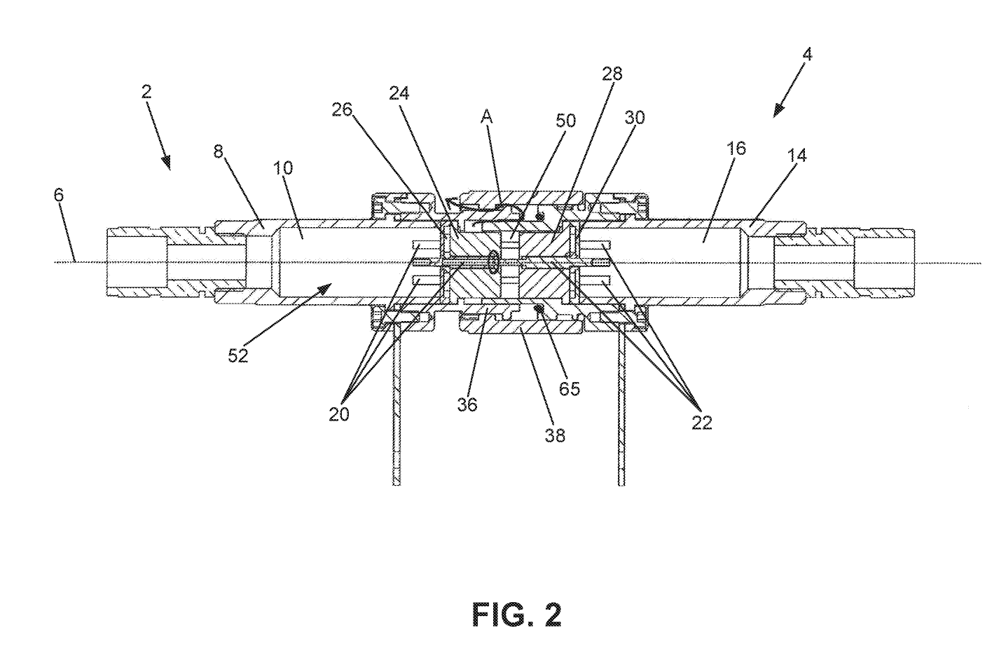

FIG. 2 shows the first and second connectors 2, 4 moved apart from one another (relative to the position shown in FIG. 1) along the attachment axis 6. With the connectors 2, 4 in the position shown in FIG. 2, their respective contacts 20, 22 are almost but are not quite touching (in this case at their respective front ends, circled in FIG. 2). When the connectors 2, 4 are in the position shown in FIG. 2 (for instance while the connectors are being connected or disconnected) a spark may jump between their respective contacts 20, 22.

With the connectors 2, 4 attached to one another, the cavities 10, 16 of their respective main bodies 8, 14 are in communication with one another via a void 50 between the inserts 24, 28, and via leakage paths (not labelled) around the inserts 24, 28 and cover plates 26, 30 (since the front ends of the cavities 10, 16 are not sealed, as discussed above). The cavities 10, 16 (and in this embodiment the void 50 and the leakage paths around the inserts 24, 28 and cover plates 26, 30) cooperatively define a chamber 52. If the pair of connectors is used in an environment which may contain a flammable or explosive material, some of this material may also be present in the chamber 52. In such a case, a spark jumping between the contacts 20, 22 may ignite this material and cause a fire or explosion within the chamber 52. Such an explosion or fire causes hot gases to be produced within the chamber 52 which may force their way out of the chamber through what is known in the art as a “flame path”.

The rear ends of the cavities 10, 16 (and thus the distal ends of the chamber 52) are sealed closed with sufficient strength for no such flame path to exist at those points. Instead, with the pair of connectors in the orientation shown in FIG. 2, the flame path leads from the chamber 52, to an external surface of one of the connectors 2, 4 (i.e. to the environment surrounding the connectors), between the attachment portions 36, 38 of the connectors. In this particular example shown, potential flame paths exist between the attachment portions 36, 38 with the connectors 2, 4 in a continuous band around the attachment axis 6. However, one or more discreet flame paths may be provided instead, at any suitable location. Arrow A denotes an exemplary flame path within the continuous band.

To prevent a fire or explosion within the chamber 52 from propagating to the environment surrounding the connectors, the flame path A is configured to be of sufficient length that any hot gases travelling along the flame path have cooled sufficiently by the time they exit, so that they are not hot enough to ignite any explosive or flammable material surrounding the connectors. In addition, with the connectors in the configuration shown, the first and second connectors 2, 4 are attached to one another so that any force produced by the explosion which tends to urge them axially away from one another (thereby shortening the length of the flame path) can be withstood. Accordingly, any spark occurring between the contacts 20, 22 is contained in a flameproof compartment and any resulting fire or explosion (as well as the spark itself) is allowed to dissipate without posing a risk to the surrounding environment. This is described in more detail below.

In conventional connectors for use in environments where explosive or flammable materials may be present, the two connectors may be attached and detached by screwing and unscrewing threaded members connected thereto. For instance, the connectors may be attached to one another using bolts, or one connecter may have an externally threaded shaft and the other connector an internally threaded sleeve. The connectors are arranged so that at the point during screwing/unscrewing at which the connectors' contacts are almost but are not quite touching, the flame path (which runs between the threaded members in the case of the latter example) is of sufficient length, and the threaded engagement is strong enough to prevent the connectors from being forced apart by an explosion or fire within a chamber of the connectors. However, manipulating threaded members (especially using a machine or while wearing gloves) can be awkward and time consuming, and the threads of the threaded members can be relatively prone to damage (either for instance from knocks or after cross-threading). The following description describes a mechanism for attaching and detaching pairs of connectors.

The first and second connectors 2, 4 are attached or detached by performing two different manipulations. More specifically, the first and second connectors 2, 4 are movable between a first configuration and a third configuration via a second configuration. A first manipulation is performed to move the connectors 2, 4 from the first configuration to the second configuration, and a second manipulation, which is different to the first manipulation, is performed to move the connectors from the second configuration to the third configuration. The connectors 2, 4 are attached to one another in the first and second configurations, and can only be detached from one another from the third configuration. This will be described in more detail below.

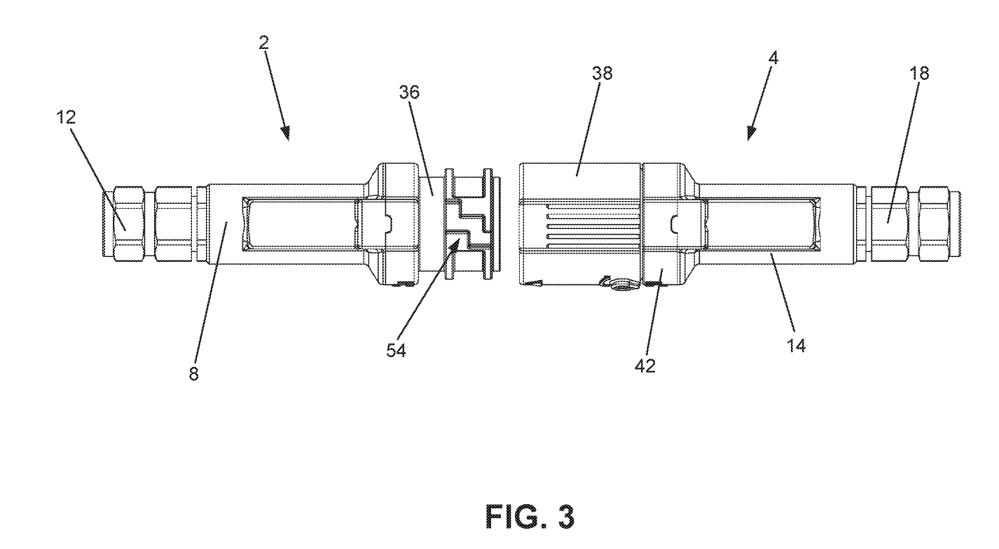

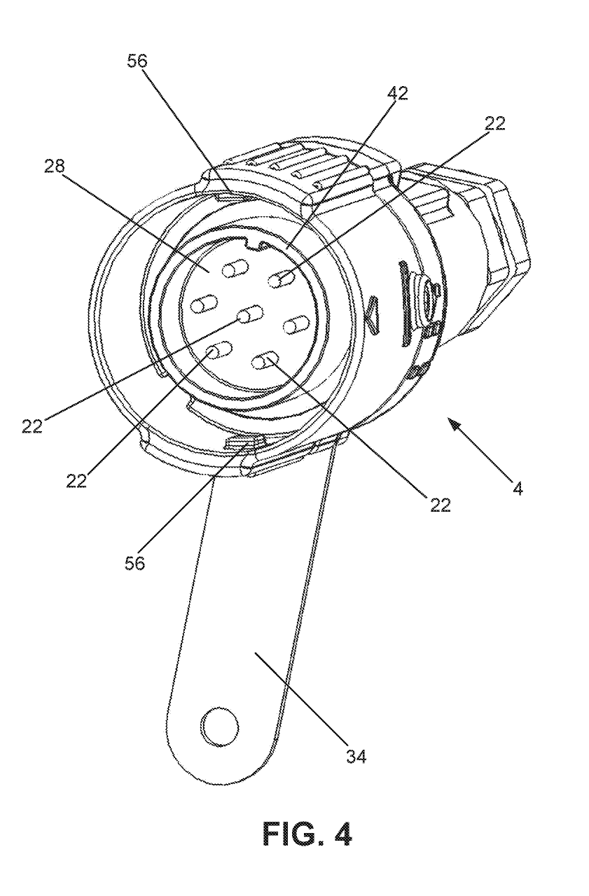

Referring now to FIGS. 3 and 4, the attachment portion 36 of the first connector 2 defines two guideways 54 (only one of which is visible), and the attachment portion 38 of the second connector 4 defines two lugs 56 which are receivable in respective guideways 54. In this case the lugs 54 project radially inwards relative to the attachment axis (not shown in FIGS. 3 and 4). FIG. 4 also illustrates the configuration of the contacts 22 in this particular embodiment. In this case there are seven contacts 22—a central contact surrounded by a substantially evenly-spaced substantially circumferential array of six other contacts. The contacts of the first connector 2 are not visible in FIGS. 3 and 4, but are arranged in the same configuration.

It is to be understood that the number of contacts and/or their spatial configurations may differ from what is shown. For instance, the optimum number and orientation of the contacts may be determined based on the space available within the connector, the number of separate connections which must be made, and the minimum clearance required between contacts so as to keep creepage at acceptable levels. Similarly, the size of the contacts may differ from what is shown. Contact size may, for instance, be determined based on the maximum current which must be carried by that contact. Although all the contacts are the same size, in other embodiments different size contacts may be present within a single connector. For instance, a connector may have one or more larger size contacts for carrying the current required for driving an electrical machine, and one or more smaller size contacts for carrying a data signal.

The attachment portion 38 of the second connector 4 takes the form of a sleeve which is movable relative to the main body 14. More particularly, in this case the sleeve 38 is rotatable about the attachment axis relative to the main body 14. Referring briefly to FIG. 1, the sleeve 38 is rotatably mounted to the main body 14 by a projection 58 which is slidably received within a circumferential recess 60 in the support portion 42 (the support portion being attached to the main body by bolts 40, as discussed above). However, the skilled person will appreciate that in other embodiments a rotatable sleeve may be attached to the main body 14 in any other suitable fashion.

An o-ring 64 is positioned between the sleeve 38 and the support portion 42. The o-ring 64 seals the boundary between the sleeve 38 and support portion 42 in this region, closing any potential flame path in this region (which would be shorter than the flame path shown by arrow A in FIG. 2). The presence of the o-ring 64 also increases the amount of friction which opposes rotation of the sleeve 38 relative to the support portion 42 (and therefore relative to the main body 14), reducing the possibility of unintentional movement of the sleeve. The connectors 2, 4 have a further o-ring 65 positioned so as to be held axially compressed between the attachment portions 36, 38 when the connectors are in the first configuration. This o-ring 65 provides a seal against dirt and moisture ingress, rather than to close off a potential flame path.

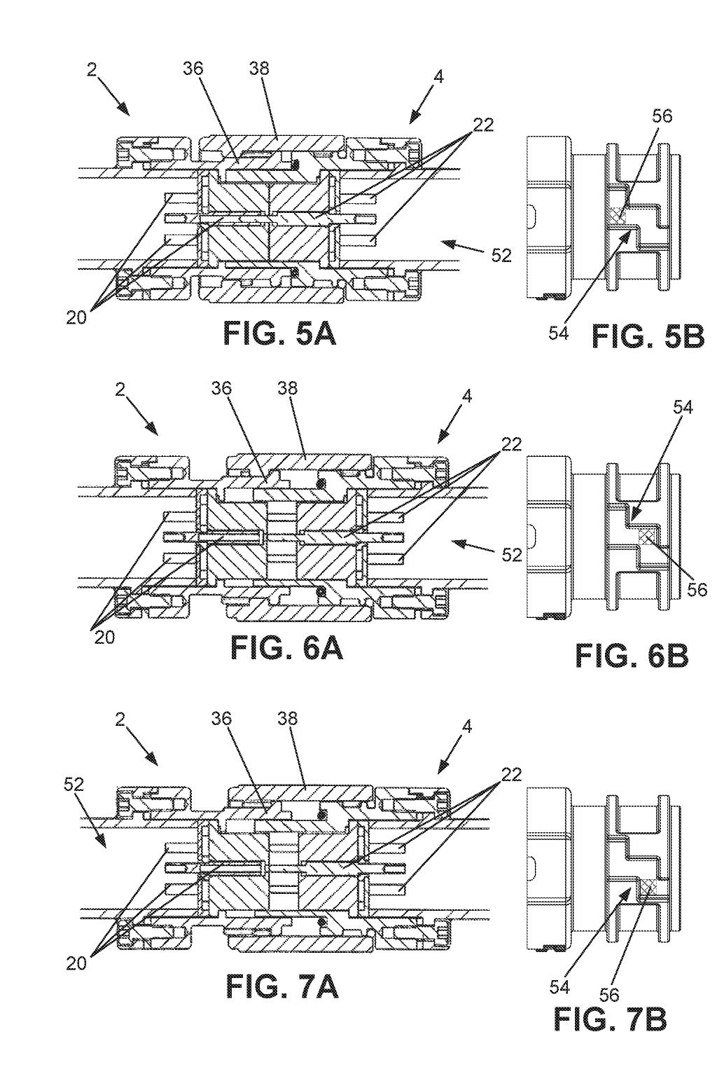

Movement of the first and second connectors 2, 4 between the first, second and third configurations is achieved by manipulating their respective attachment portions 36, 38 so as to move the lugs 56 within the guideways 54. FIGS. 5A, 6A and 7A show the positions of the connectors 2, 4 in the first, second and third configurations respectively. FIGS. 5B, 6B and 7B show the position of the upper lug 56 (from the perspective of FIGS. 5A, 6A and 7A) in the upper guide-way 54 (from the perspective of FIGS. 5A, 6A and 7A) for each configuration.

As shown in FIG. 5A, in the first configuration the contacts 20, 22 of the connectors 2, 4 are touching, and in the second configuration the contacts are not touching. Accordingly, any sparking between the contacts will take place during movement between the first configuration and the second configuration. In both the first and second configurations the connectors 2, 4 are attached to one another, this attachment is strong enough to resist a force from a fire or explosion in the chamber 52 urging the connectors apart. That is, means are provided to retain the connectors 2, 4 from axial separation from the second configuration. This is discussed in more detail below. The connectors 2, 4 are arranged such that when in the second configuration, the flame path (A in FIG. 2) is of sufficient length in comparison to the volume of the chamber 52 that gas forced through the flame path A by a fire or explosion has cooled below the temperature at which it would ignite any flammable or explosive material in the surrounding environment by the time it emerges from the flame path. More particularly, the length of the flame path relative to the volume of the chamber 52 adheres to British Standard BS EN 60079-1:2007, which is incorporated herein by reference.

Furthermore, the connectors 2, 4 are configured such that a fire or explosion in the chamber 52 may move the connectors away from the first configuration and towards the second configuration, but cannot move them any further than the second configuration (i.e. towards the third configuration). Accordingly, if a spark jumps between the contacts 20, 22 while the connectors 2, 4 are being moved between the first configuration and the second configuration, the connectors are prevented from moving to a position in which the flame path is too short. The spark igniting flammable or explosive material within the environment is therefore avoided.

Connectors described can therefore provide the same level of safety as conventional connectors which use threaded members, but with two different manipulations being required to attach/detach them (instead of a single continuous manipulation as is the case with conventional connectors) may allow connectors according to the present invention to provide advantageous speed, simplicity and ease of use. The above functionality is provided by the attachment portions 36, 38 of the first and second connectors 2, 4, and more specifically the first and second manipulations include relative movement of the attachment portions in different directions. This is discussed in more detail below.

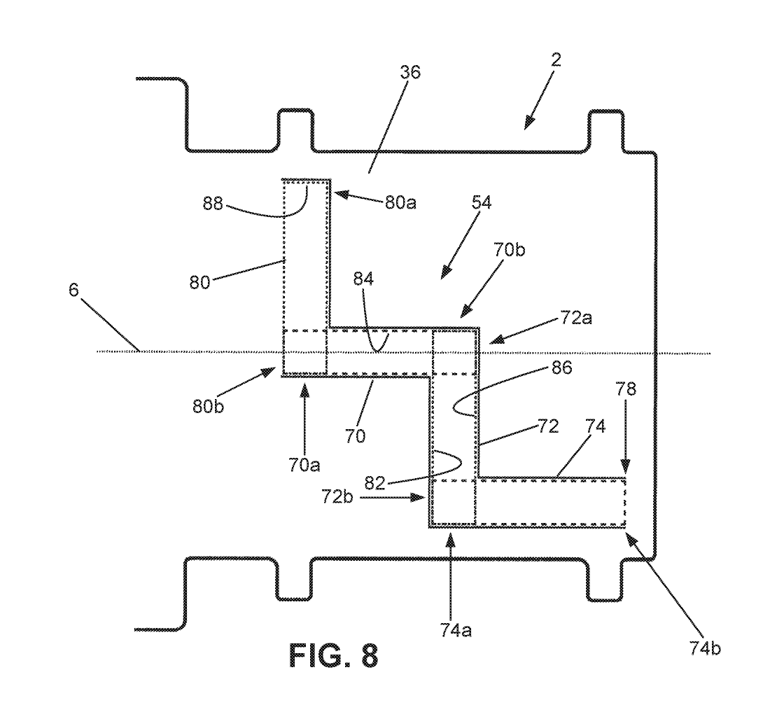

FIG. 8 illustrates one of the guideways 54 of the attachment portion 36 of the first connector 2, with the shape of the guideway 54 exaggerated for the sake of clarity. The structure and function of the guideways 54 will be described in relation to this single guideway and its associated lug 56. It is to be understood that in this example, the other guideway and the other lug have the same structure and interact in the same fashion.

The guideway 54 has a disconnection section 70, an intermediate section 72 and a release section 74. Each of the sections 70, 72 and 74 has two ends. One end 72a of the intermediate section 72 intersects an end 70b of the disconnection section 70, and the other end 72b of the intermediate section 72 intersects an end 74a of the release section 74. The end 74b of the release section 74 which does not intersect the intermediate section 72 has a mouth 78 through which the lug 56 can pass so as to allow the connectors to be separated from one another entirely. It will be apparent from FIG. 8 that if the lug 56 is positioned within the guideway 54 in the disconnection section 70 or in a part of the intermediate section 72 other than the end 72b that intersects the release section 74, the lug needs to be positioned at the intersection between the intermediate section 72 and release section 74 (at ends 72b and 74a) before it can pass out of the guideway 54 through the mouth 78. Accordingly, with the connectors 2, 4 in either the first configuration or the second configuration, movement to the third configuration is required before they can be detached entirely from one another.

As will be apparent by comparing FIGS. 5B, 6B and 7B to FIG. 8, with the connectors 2, 4 in the first configuration the lug 56 is received in the guideway 54 at the end 70a of the disconnection section 70 which does not intersect the intermediate section 72. Similarly, with the first and second connectors 2, 4 in the second configuration, the lug 56 is received in the guideway 54 at the end 72a of the intermediate section 72 which intersects the disconnection section 70. Furthermore, it will be apparent that with the connectors 2, 4 in the third configuration the lug 56 is received in the guideway 54 at the end 72b of the intermediate section 72 which intersects the release section 74. Accordingly, moving the connectors from the first configuration to the second configuration (i.e. performing the first manipulation) moves the lug 56 along the disconnection section 70 from the end 70a which does not intersect the intermediate section 72, to the end 70b which does intersect the intermediate section 72. Similarly, moving the connectors from the second configuration to a third configuration (i.e. performing the second manipulation) requires movement of the lug 56 from the end 72a of the intermediate section 72 which intersects the disconnection section 70 to the end 72b which intersects the release section 74.

The disconnection section 70 is aligned substantially parallel to the attachment axis 6, the intermediate section 72 is aligned substantially circumferentially about the attachment axis, and the release section 74 is aligned substantially parallel to the attachment axis. Accordingly, to move the connectors 2, 4 from the first configuration to the second configuration (i.e. performing the first manipulation, requiring the lug to move from end 70a of disconnection section 70 to end 70b of disconnection section 70), the lug and guideway are move relative to one another along the attachment axis. In this embodiment, this is achieved by pulling the connectors 2, 4 apart along the attachment axis 6 (as described in more detail below), thereby pulling apart their respective attachment portions 36, 38. Similarly, to separate the connectors from the third configuration (which requires the lug 56 to move from end 74a of the release section to end 74b of the release section and out of the mouth 78), the lug and guideway are moved relative to one another along the attachment axis. Again, this is achieved by pulling the connectors 2, 4 apart along the attachment axis 6 so as to pull apart their respective attachment portions 36, 38. Furthermore, to move the connectors 2, 4 from the second configuration to the third configuration (i.e. performing the second manipulation, which requires the lug 56 to move from end 72a of the intermediate section 72 to end 72a), the attachment portions 36, 38 are rotated relative to one another about the attachment axis 6. In this embodiment, this is achieved by rotating the sleeve 38 about the attachment axis 6 relative to the main body 14 (thereby rotating it relative to the attachment portion 36 of the first connector 2).

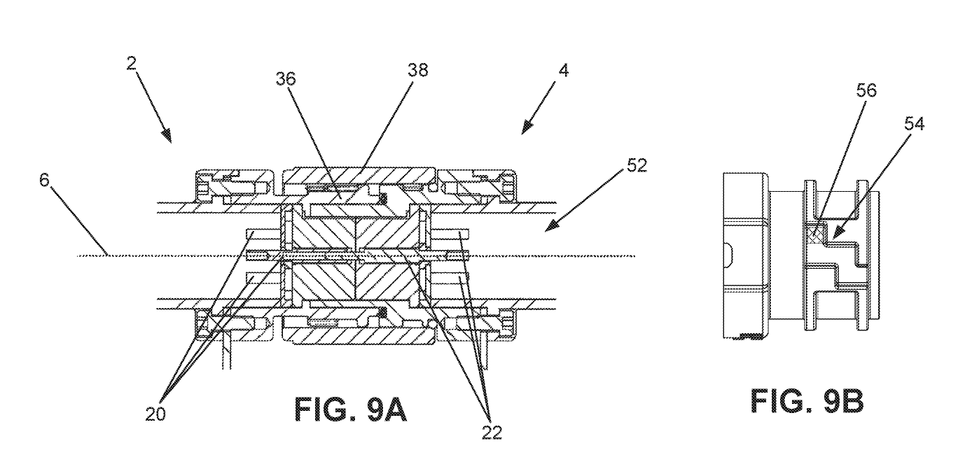

The first and second connectors 2, 4 are also movable relative to one another between the first configuration and a fourth configuration. FIG. 9A shows the connectors 2, 4 in the fourth configuration, and FIG. 9B shows the position of the upper lug 54 (from the perspective of FIG. 9A) within the upper guideway 54 (from the perspective of FIG. 9A) when the connectors are in this configuration. The connectors 2, 4 being movable to the fourth configuration can reduce the risk of the connectors moving towards the second configuration (at which point their respective contacts 20, 22 cease to be in contact and any electrical/optical signal or electric current passing therebetween is interrupted) unintentionally. Movement of the connectors 2, 4 between the first and fourth configurations requires a third manipulation to be performed, as discussed below.

In this example, the movement of the connectors 2, 4 between the first and fourth configurations is accommodated movement of the lug 56 within the guideway 54 due to the presence of an additional section of the guideway 42. Returning to FIG. 8, the guideway 54 also has a locking section 80. Like the disconnection section 70, intermediate section 72 and release section 74, the locking section 80 has two ends 80a, 80b. End 80b of the locking section intersects the disconnection section 70 at the end 70A thereof which does not intersect the intermediate section 72. In this embodiment the locking section 80 is not fully enclosed—its rear side (its left side from the perspective of FIG. 8) is left open. However, the connectors 2, 4 are configured such that the electrically insulating inserts which support the contacts (not shown in FIG. 8) abut, thereby preventing the connectors from moving any further towards one another. This prevents the lug (not visible in FIG. 8) from moving axially rearwards out of the locking section 80. It should be noted, however, that in other embodiments the locking section may be fully enclosed and/or other sections of the guideway may not be fully enclosed.

To perform the third manipulation in this embodiment, the lug 56 is moved from the intersection between the disconnection section 70 and the locking section 80 to the end 80a of the locking section which does not intersect the disconnection section. In this particular embodiment the locking section 80 is aligned substantially circumferentially around the attachment axis 6, therefore to perform the third manipulation the attachment portions 36, 38 are rotated relative to one another about the attachment axis 6. In the present embodiment this is achieved by rotating the sleeve 38 about the attachment axis 6 relative to the main body 14 (thereby rotating it relative to the attachment portion 36 of the first connector 2). Accordingly, in this case the third manipulation is the same as the second manipulation.

The process for connecting and disconnecting the connectors 2, 4 will now be described with reference to FIGS. 1 and 5A to 9B. For simplicity, this process will be described in relation to the movement of one lug 56 through the corresponding guideway 54. It is to be understood that the other lug interacts with the other guideway in the same fashion.

To connect the connectors 2, 4, they are introduced towards one another along the attachment axis 6, with the attachment portions 36, 38 of the connectors positioned at the appropriate angle relative to one another for the lug 56 to enter the guideway 54 through the mouth 78 of the release section 74 of the guideway. The connectors 2, 4 continue to be moved towards one another along the attachment axis 6, during which time the lug 56 travels along the release section 74 of the guideway 54 towards end 74a. When the lug 56 reaches the end 74a of the release section which intersects the end 72b of the intermediate section 72, the connectors 2, 4 are in the third configuration. At this point, further axial movement of the connectors 2, 4 towards one another is prevented by the lug 56 contacting a wall 82 of the guideway 54.

With the connectors 2, 4 in the third configuration, the second manipulation of this embodiment is performed—the sleeve 38 is rotated about the attachment axis 6 relative to the main body 14 of the second connector (and therefore relative to the main body 8 and the attachment portion 36 of the first connector 2). That is, an external force is applied to the sleeve 38 so as to move it in a direction which is transverse to the attachment axis 6. The lug 56 therefore begins to travel along the intermediate section 72 of the guideway 54, from the end 72b which intersects the release section 74, towards the end 72a which intersects the disconnection section 70. When the sleeve 38 reaches the angular position relative to the attachment portion 36 at which the lug 56 is received at the intersection between the intermediate section 72 and the disconnection section 70, the connectors are in the second configuration. Further circumferential movement of the sleeve 38 relative to the attachment portion 36 is then prevented by the lug 56 contacting another wall 84 of the guideway 54.

The connectors 2, 4 (and thus their attachment portions 36, 38) are then pushed towards one another along the attachment axis 6, thereby performing the first manipulation of this embodiment. This moves the lug 56 along the disconnection section 70 from the end 70b which intersects the intermediate section 72 to the end 70a which intersects the locking section 80 (i.e. the end which does not intersect the intermediate section 72). As the connectors 2, 4 move towards one another and the lug 56 travels along the disconnection section, the connectors reach a position at which their respective contacts 20, 22 are almost but are not quite touching (i.e. the position shown in FIG. 2). If a spark jumps between the contacts 20, 22 at that point and ignites flammable or explosive material within the chamber 52, the connectors 2, 4 may be forced apart from one another by gases released by a fire or explosion within the chamber. However, if the connectors 2, 4 are forced apart by a fire or explosion, they cannot move apart beyond the second configuration because at that point the lug 56 is prevented from moving any further in the axial direction by a wall 86 of the guideway. Wall 86 therefore functions as a stop surface to prevent axial separation of the connectors 2, 4.

Since the flame path (Arrow A in FIG. 2) with the connectors 2, 4 in the second configuration is of sufficient length that when any gas produced by a fire or explosion in the chamber 52 exits the flame path the gas has cooled below the temperature which would ignite explosive or flammable material around the connectors, any such fire or explosion is prevented from propagating. If no such fire or explosion occurs, the connectors 2, 4 can continue to move towards one another along the attachment axis 6 until they reach the first configuration, at which point their respective contacts 20, 22 are touching and the lug 56 is received at the intersection between the disconnection section 70 and the locking section 80 (i.e. at the end 70a of the disconnection section 70 which does not intersect the intermediate section 72). In some situations the connectors 2, 4 may also be moved to the first configuration after a fire or explosion has taken place within the chamber 52, however in some cases it may be preferable for the connectors 2, 4 to be inspected (for instance to check the integrity of the seals provided by the cable glands 12, 18 and the o-ring 64) before returning them to service.

In some example implementations the connectors 2, 4 may remain in the first configuration during normal use (for instance while electrical/optical signals or electric current passes between their respective contacts, 20, 22). For instance, there may be sufficient friction between the first and second connectors 2, 4 to prevent them being moved towards the second configuration inadvertently (for instance by a knock). However, in this embodiment the connectors 2, 4 are moved from the first configuration to the fourth configuration for the sake of additional protection from accidental disconnection of their contacts 20, 22. To move the connectors 2, 4 from the first configuration to the fourth configuration (i.e. to perform the third manipulation), the sleeve 38 is rotated around the attachment axis 6 relative to the main body 14 of the second connector 4 (and thus relative to the main body 8 and attachment portion 36 of the first connector 2). This causes the lug 56 to travel along the locking section 80 from the end 80b which intersects the disconnection section 70 to the end 80a which does not intersect the disconnection section. When the sleeve has rotated to the point at which the connectors 2, 4 are in the fourth configuration, further rotation of the sleeve 38 is prevented by a wall 88 of the guideway 54 contacting the lug 56.

To disconnect the connectors 2, 4, the above procedure is reversed. Firstly, the third manipulation is performed such that the sleeve 38 is rotated about the attachment axis 6 so that the lug 56 travels along the locking section 80 of the guideway 54 from the end 80a which does not intersect the disconnection section 70. When the lug 56 reaches the intersection between the locking section 80 and the disconnection section 70, the connectors are back in the first configuration. At that point, the first manipulation is performed to move the connectors 2, 4 from the first configuration to the second configuration—the connectors, 2, 4 are pulled apart from one another along the attachment axis 6, therefore the lug 56 travels along the disconnection section 70 towards the intermediate section 72. Again, as the connectors 2, 4 move apart from one another along the attachment axis 6, they reach a point at which their respective contacts, 20, 22 are almost but are not quite touching.

In the same manner as described above, if a spark jumps between the contacts 20, 22 and ignites an explosive or flammable material within the chamber 52, the gases produced may force the connectors apart to the second configuration but further movement apart is prevented by the wall 86 of the guideway 54 contacting the lug 56. If no such fire or explosion takes place, or if the fire or explosion does not provide sufficient force to move the connectors 2, 4 to the second configuration, they continue to be pulled apart until they reach the second configuration. The second manipulation is then performed—the sleeve 38 is rotated once again, moving the lug 56 along the intermediate section 72 from the end 72a which intersects the disconnection section 70 to the end 72b which intersects the release section. In other words, an external force is applied to the sleeve 38 to move it in a direction which is transverse to the attachment axis 6. When the sleeve 38 has been rotated sufficiently for the lug 56 to be received at the intersection between the intermediate section 72 and the release section 74, the connectors 2, 4 are in the third configuration. At that point, the connectors 2, 4 are pulled apart from one another along the attachment axis 6, the lug travels along the release section 74 and exits through the mouth 78 at the end 74b of the release section 74 which does not intersect the intermediate section 72. The connectors can then be separated from one another entirely.

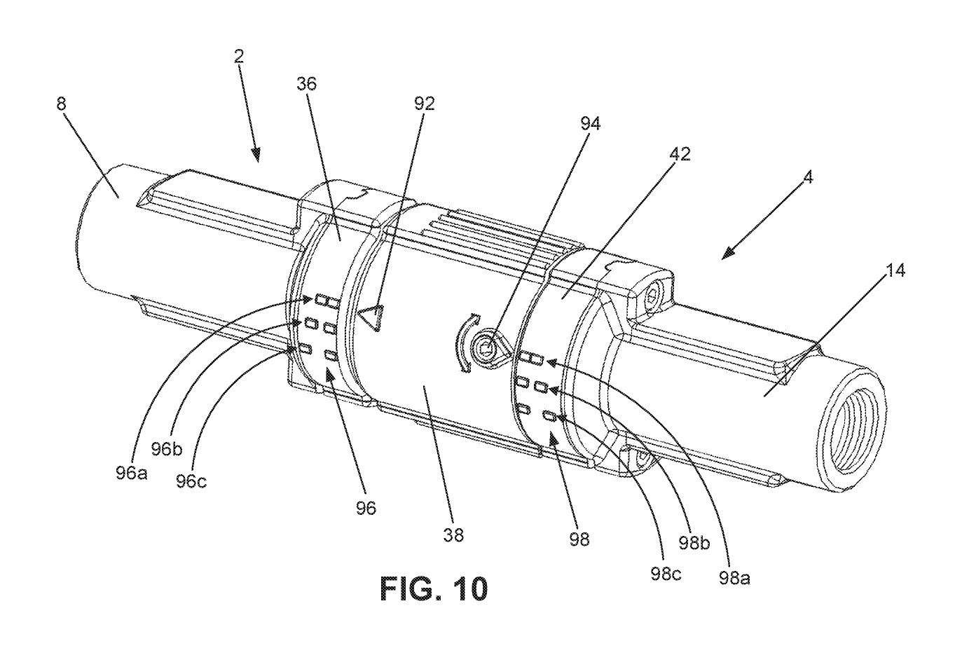

FIG. 10 shows the sleeve 38 provided with two pointers 92, 94. Pointer 92 is used in conjunction with indicia 96 provided on the first connector 2 (in this case on its attachment portion 36), and pointer 94 is used in conjunction with indicia 98 provided on the second connector 4 (in this case on its support portion 42). Each set of indicia 96, 98 comprises three graduations 96a-96c, 98a-98c.

Pointer 94 and indicia 98 cooperatively form markings which indicate the position of the sleeve 38 relative to the support portion 42 (and thus relative to the main body 14 of the second connector 2) as follows. Pointer 94 being aligned with graduation 98a indicates that the sleeve 38 is in the rotational position relative to the main body 14 of the second connector 4 that corresponds to the connectors 2, 4 being in the fourth configuration described above. Pointer 94 being aligned with graduation 98b indicates that the sleeve 38 is in the rotational position relative to the main body 14 of the second connector 2 that corresponds to the connectors being in first configuration or the second configuration. The pointer 94 being aligned with graduation 98c indicates that the sleeve 38 is in the rotational position relative to the main body 14 that corresponds to the connectors 2, 4 being in the third configuration (or in a position at which they had been pulled axially apart from the third configuration, with the lug 56 positioned at some point along the length of the release section 74 of the guideway 54).

Although the markings formed by the pointer 94 and indicia 98 give an indication of the position of the sleeve 38 relative to the main body 14 of the second connector 4, the axial spacing between portions of the first and second connectors (e.g. the sleeve 38 of the second connector 4 and the attachment portion 36 of the first connector) should also be assessed in order for the configuration of the connectors 2, 4 to be deduced with any certainty. For instance, the sleeve 38 may be rotated relative to the main body 14 of the second connector 4 so that the pointer 94 is aligned with graduation 98a while the connectors 2, 4 are completely separate from one another. The markings formed by the pointer 94 and the graduation 98a may suggest that the connectors are in the fourth configuration, but an operator would note from the presence of a gap between sleeve the front end of the sleeve 38 and the front end of the visible part of the attachment portion 36 that this is not the case. Similarly, if the operator were to note that the pointer 94 was aligned with the graduation 98b, he would deduce whether the connectors 2, 4 were in the first configuration or the second configuration (or neither) based on the space between the front end of the sleeve 38 and the front end of the visible part of the attachment portion 36.

Pointer 92 and indicia 96 work in the same fashion as pointer 94 and indicia 98, but denote the angular position of the sleeve 38 relative to the attachment portion 36 of the first connector 2. The indicia 96, 98 of this example can perform another function—showing whether or not the attachment portion 36 of the first connector 2 is rotationally aligned with the support portion 42 of the second connector 4. This indication then provides a guide as to whether or not the contacts 20, 22 of the connectors 2, 4 are aligned with one another so that (at the appropriate point) the male contacts 22 can enter the female contacts 20.

In this case the three graduations 96a-96c, 98a-98c each have a shape which represents the possible configuration(s) of the connectors (two blocks touching each other to represent the fourth configuration, two blocks nearby each other to represent the first or second configuration, and two blocks further apart to represent the third configurations). However, it will be appreciated that in other cases any other suitable arrangement of markings may be used. For instance, the sleeve may comprise the indicia rather than the pointer, and/or the or each set of indicia may comprise greater than or fewer than three graduations (for instance a single graduation, the position of the sleeve being determined by the relative positions of the graduation and the corresponding pointer). Instead or in addition, in some embodiments markings may be provided which indicate the axial spacing between components of the connectors (for instance the part of the attachment portion 36 which is received within the sleeve 38 may be provided with axially-arranged indicia).

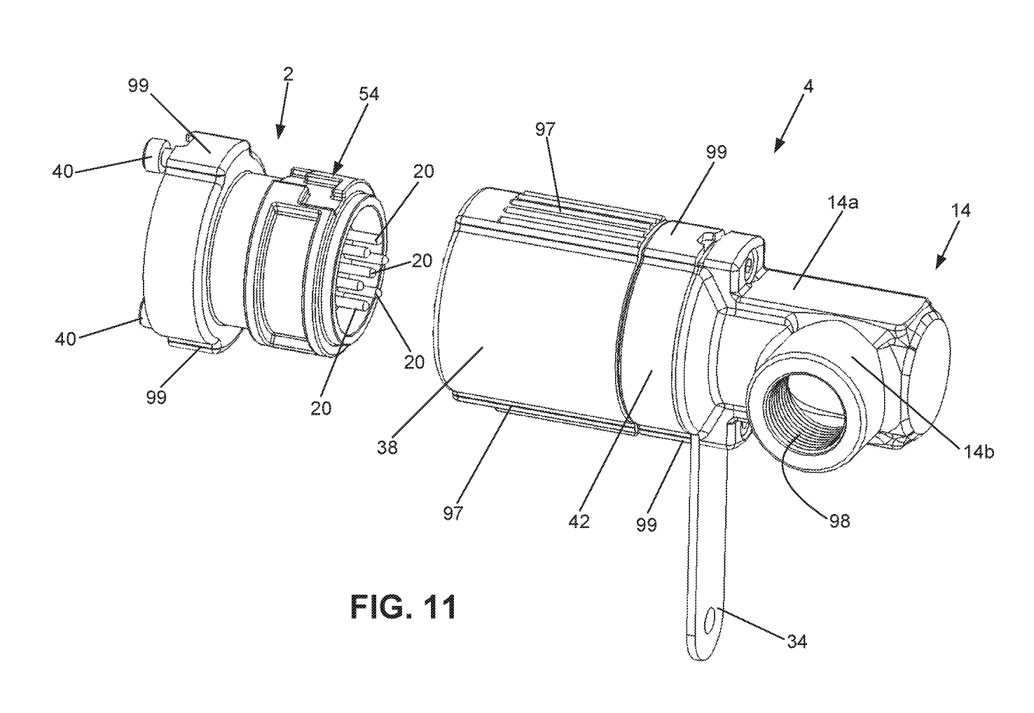

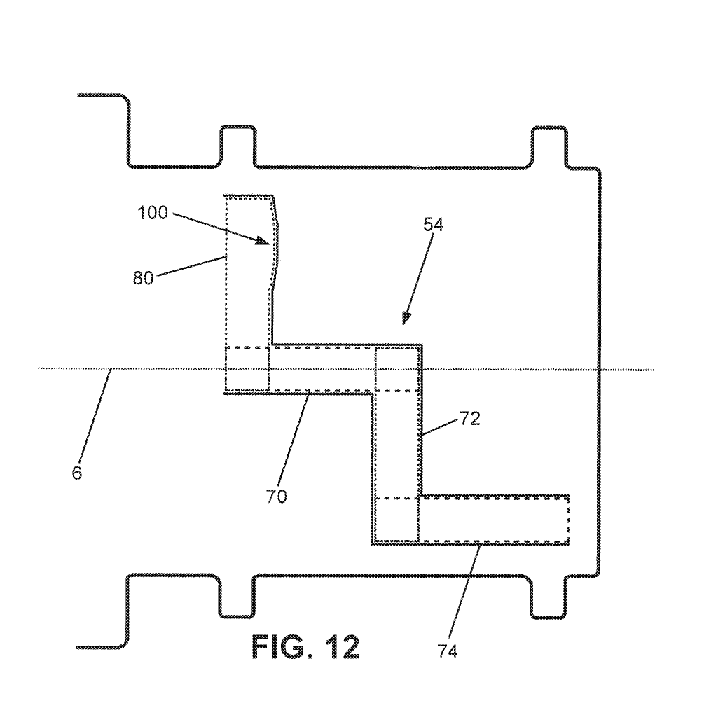

A pair of connectors is shown in FIG. 11, which are similar to the connectors described in FIG. 1, with the following differences. Firstly, the first connector 2 is not configured for attachment to an electrical cable. Instead, the first connector 2 is arranged to be secured to a casing of an electrical unit (not visible) such as a sensor assembly or sensor readout screen, in this case by bolts 40. Since the first connector is intended to be attached to a casing of an electrical unit, the first connector 2 can be moved by moving the electrical unit. The first connector 2 therefore is not provided with a handle. Furthermore, although the contacts 20 of the first connector are arranged in the same spatial configuration as in FIG. 4, in this example the contacts 20 of the first connector 2 are male contacts and the contacts (not visible) of the second connector 4 are female.

The connectors shown in FIG. 11 also differs from the connectors of FIG. 1 in that the main body 14 of the second connector 4 defines a right angle turn—the first portion 14a of the main body 14 is aligned with the attachment axis (not shown), and a second portion 14b projects perpendicularly therefrom. The second portion 14B has a threaded bore 98 for receipt of a cable gland (not shown) so that the second connector can be attached to an electrical cable in a conventional manner.

It will also be apparent that the connectors 2, 4 of FIG. 11 do not have markings to indicate the rotational position of the sleeve 38. In this case, an operator can rely on tactile feedback to determine what configuration the connectors 2, 4 are in, and/or may make a judgment based on the relative positions of raised and textured portions 97 of the sleeve 38 relative to raised portions 99 provided on the first and second connectors 2, 4.

The shape of the guideways 54 (only one of which is visible in FIG. 11) of the first connector 2 also differs from that shown in FIG. 8. FIG. 12 shows a schematic representation of the upper guideway 54 (from the perspective of FIG. 11), with the shape of the guideway exaggerated for the sake of clarity. The disconnection section 70, intermediate section 72 and release section 74 of the guideway 54 are substantially the same as the corresponding sections of the guideway shown in FIG. 8. However, as shown in FIG. 11, the locking section 80 has a recess 100 into which the lug 56 can be received. Furthermore, the o-ring which is axially compressed between the attachment portions 36, 38 when the connectors 2, 4 are in the first configuration (reference 65 in FIG. 1) is also axially compressed when the connectors 2, 4 are in the fourth configuration. The restorative force from the axial compression of this o-ring urges the attachment portions 36, 38 (and thus the connectors 2, 4) axially apart.

With the connectors 2, 4 in the fourth configuration, the lug 56 is aligned with the recess 100 of the locking section 80. The attachment portions 36, 38 being urged apart by the o-ring (56 in FIG. 1) urges the lug 56 into the recess 100 in the guideway 54. The o-ring therefore acts as a resilient member which biases the lug 65 into the recess 100. The o-ring urging the lug 56 into the recess 100 may reduce the risk of the connectors inadvertently being moved from the fourth configuration to the first configuration (for instance by a knock), since moving the lug out of the recess 100 requires the o-ring to be axially compressed again, and therefore more force is required than if moving the lug within a locking section 80 merely required friction to be overcome. In other examples this functionality may be provided by a different component or set of components. For instance, the electrically insulating inserts may be slightly elastic, and be configured so that when the connectors are in the fourth configuration they are compressed slightly and urge the connectors apart along the attachment axis 6.

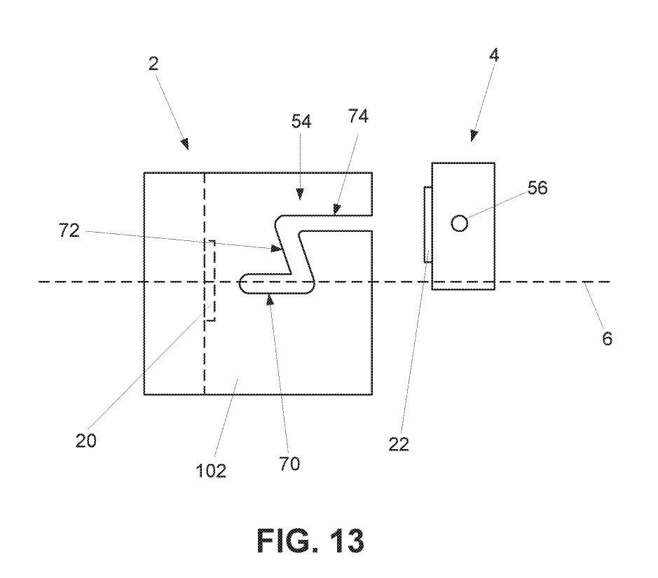

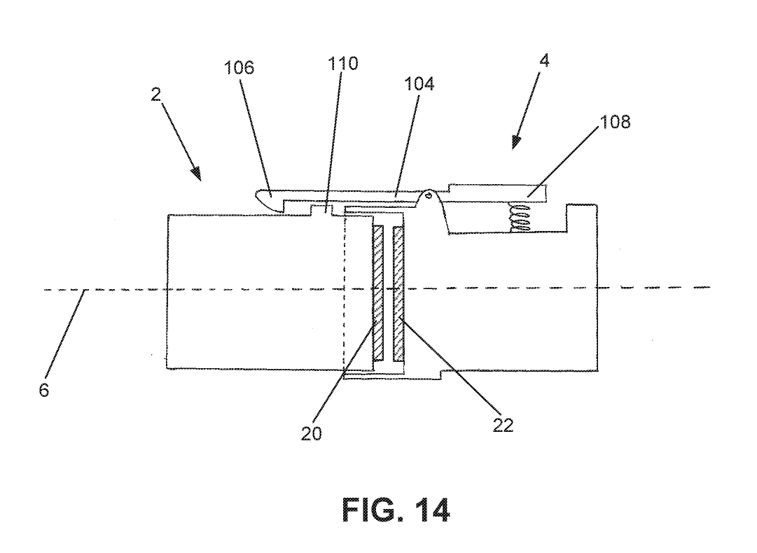

A schematic illustration of a third example of a connector is shown in FIG. 13. In this example each connector 2, 4 has a single contact 20, 22 in the form of a flat plate. The plates abut when the connectors 2, 4 are in the first configuration. The first connector 2 is provided with an attachment portion in the form of a pair of flat guide-plates 102 (one of which is shown in FIG. 13). Each side plate 102 of the first connector has a guideway 54 that has a disconnection section 70, an intermediate section 72 and a release section 74. The attachment portion of the second connector 4 has a pair of lugs 56 in the form of short pins projecting from either side. The pins 56 are receivable in the guideways 54. As with the previous description, the attachment mechanism of the connectors 2, 4 will be described in relation to a single lug 56 and guideway 54, it being understood that the same process also occurs at the other guideway (not visible) with respect to the other lug (not visible).

It will be apparent from FIG. 13 that the disconnection section 70 and the release section 74 of the guideway 54 are aligned substantially parallel to the attachment axis 6. Accordingly, moving the connectors from the first configuration to the second configuration (i.e. performing the first manipulation, moving the lug 56 along the disconnection section 70 towards the intermediate section 72) requires relative movement of the connectors 2, 4 away from one another in a direction parallel to the attachment axis 6, as was the case described above. The same applies in relation to moving the connectors (and thus their attachment portions) from the third configuration to a configuration in which they are entirely separate (i.e. moving the lug 56 along the release section 74 away from the intermediate section 72). However, it will be apparent that the intermediate section 72 is not positioned circumferentially around the attachment axis 6. Instead, the intermediate section 72 runs along a straight path which is positioned at an angle to the attachment axis 6 (from the perspective of FIG. 13). Accordingly, moving the connectors 2, 4 from the second configuration to the third configuration (i.e. performing the second manipulation, moving the lug 56 along the intermediate section 72 away from the disconnection section 70 and towards the release section 74) does not require relative rotation about the attachment axis 6. Instead, the connectors 2, 4 are moved relative to one another in a linear direction which has a vector component in a direction which is transverse to the attachment axis 6 (i.e. the vertical direction from the perspective of FIG. 13).

A schematic illustration of an example pair of connectors is shown in FIG. 14. In this case, the connectors 2, 4 do not have a guideway and lug respectively. Instead, they can be attached to one another using a pivotable catch 104 with a head 106 and button 108 (that forms the attachment portion of the second connector 4), which interacts with a ridge 110 which forms the attachment portion of the first connector 2. In the first configuration the connectors 2,4 are closer together than is shown in FIG. 14, with their respective contacts 20, 22 touching and the head 106 of the catch 104 positioned further behind the ridge 110 than is shown. In the second configuration the connectors 2, 4 are spaced apart from one another along the attachment axis 6 (relative to the position shown in FIG. 14), their respective contacts 20, 22 do not touch and the head 106 of the catch 104 abuts the rear of the ridge 110. In the third configuration the connectors 2, 4 are spaced apart further still, and the head 106 of the catch 104 is positioned in front of the ridge 110.

To move the connectors 2, 4 from the first configuration to the second configuration (i.e. to perform the first manipulation) they are pulled apart along the attachment axis 6. To move the connectors 2, 4 from the second configuration to the third configuration are again pulled apart along the attachment axis. In addition, however, the catch 104 is pivoted by applying an external force to the button 108 so as to lift its head 106 over the ridge 110. This is the second manipulation.

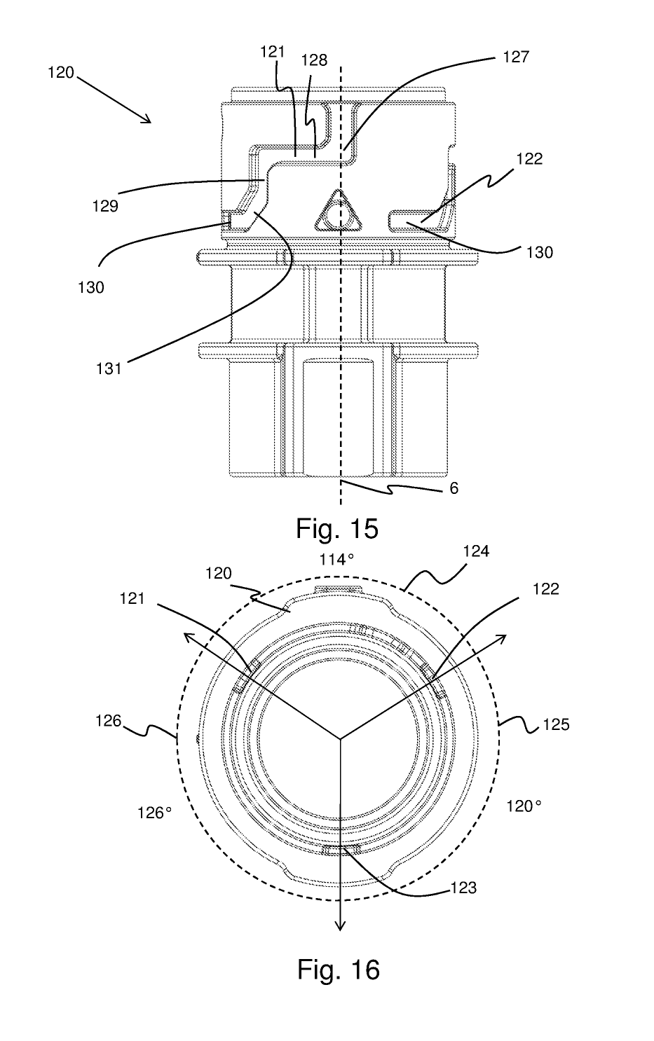

FIG. 15 shows an attachment portion 120 according to an embodiment of the invention. The attachment portion 120 is similar to the attachment portion 36 shown in FIG. 3 and is arranged to mate with a second attachment portion (not shown). The attachment portion 120 comprises a first guideway 121, a second guideway 122 and a third guideway 123 (the third guideway is not visible in FIG. 15), which perform a similar function to the guideways 54 described above. As in the connectors described above with respect to guideways 54, the first, second and third guideways 121, 122, 123 are circumferentially arranged about the surface of the attachment portion 120. As in the connectors described above, the guideways 121, 122, 123 are configured so as to each receive a corresponding lug (not shown) defined on a second attachment portion of a second connector, such that the two connectors may be attached to one another along the attachment axis 6 in a similar manner to that described above.

The angular distance between each of the first guideway 121, second guideway 122 and third guideway 123 differ. Referring to FIG. 16, which shows an end view of the attachment portion 120, there is a first angle 124 between the first guideway 121 and the second guideway 122, a second angle 125 between the second guideway 102 and the third guideway 123, and a third angle 126 between the first guideway 121 and the third guideway 123.

In the embodiment shown in FIG. 16, the first angle 124 is 114 degrees, the second angle 125 is 120 degrees and the third angle 126 is 126 degrees. The first guideway 121 has been angularly offset by 6 degrees with respect to an angular position equidistance from the second and third guideways. In other words, the first guideway 121 has been offset from a position which would provide an even distribution of guideways. The offset of the first guideway 121 provides the attachment portion 120 with a rotational symmetry of order one about its attachment axis 6. The offset may be measured from a central position of each mouth of each guideway, where as above, the mouth allows the lug to enter the guideway. A corresponding offset in angular position will also be present in the arrangement of lugs on the attachment portion of the second connector such that each lug may mate with its respective guideway.

Providing the attachment portion 120 with a rotational symmetry of order one in the manner described ensures that a connector comprising the attachment portion 120 can only be connected with a corresponding connector in a single orientation. This is in contrast to the attachment portions 36, 38, described above, which, in the absence of any other mechanism preventing attachment, can be attached in one of two orientations, since the two lugs 56 and two guideways 54 are symmetrically arranged on the attachment portions 36, 38.

The angular offset of one of the guideways may be any value so as to provide a rotational symmetry of one. However, it is advantageous that the angular offset of one of the guideways is relatively small so as to not significantly reduce the stability and robustness of the connection between two connectors. The greatest stability can be achieved by arranging the lugs and guideways 121, 122, 123 such that they are separated by an equal angular distance as this helps evenly distribute force or moment experienced between the lugs and guideways during use. That is, when using three guideways/lugs, an angular spacing of 120 degrees apart provides the most robust configuration for distributing forces encounter by the connector, although has a rotational symmetry of order three. Therefore, offsetting one of the lugs/guideways so as to provide a rotational symmetry of one means that, on average, the force experienced by the lugs/guideways may not be equally spread. The greater the angular offset, the greater the difference in force acting on the lugs/guideways and the less robust the connection will be. Therefore, it is advantageous for the offset to be great enough so as to provide a rotation symmetry of one, but not so great as to unduly compromise the stability of the connector.

In an embodiment, the offset is less than or equal to about 28 degrees. In another embodiment the offset is less than or equal to about 12 degrees. That is, one of the guideway/lug pairs is offset by 12 degrees from a position which would provide an even distribution of guideways/lugs. For example, in the example shown in FIG. 16, if the offset is 12 degrees, the first angle may be 108 degrees, the second angle may be 120 degrees and the third angle may be 132 degrees. In another embodiment, the offset is less than or equal to about 10 degrees. In another embodiment, the offset is less than or equal to about 6 degrees. In another embodiment, the offset is less than or equal to about 3 degrees.

More than one of the guideway/lug pairs may be offset. For example, the first angle 124 may be 122 degrees, the second angle 125 may be 116 degrees, and the third angle 126 may be 122 degrees. That is, the second guideway 122 has been offset by 2 degrees in the clockwise direction from a position which is separated by 120 degrees from the first guideway 121 (when viewed in FIG. 16), and the third guideway 123 has been offset by 2 degrees in the anti-clockwise direction from a position which is separated by 120 degrees from the first guideway 121.

The guideways 121, 122, 123 comprise a release section 127, intermediate section 128, disconnection section 129 and locking section 130 as in the connector shown in FIG. 8 and described above. As described above with respect to locking section 80 and disconnection section 70, the locking section 130 is arrange transverse to the axial direction (attachment axis 6) and the disconnection section 129 is arranged parallel to the axial direction (attachment axis 6). However, the guideways 121, 122, 123 differ from the guideway 54 shown in FIG. 8 in that the guideways 121, 122, 123 comprise an intermediate portion 131. The intermediate portion 131 is located between the disconnection section 129 and the locking section 130, and is angled relative to the disconnection section 129 and the locking section 130. That is, the intermediate portion 131 extends both axially along the attachment axis 6 and circumferentially (transversely).

This intermediate portion 131 helps provide a mechanical advantage when disconnecting a second connector from the attachment portion 120. For example, consider the case where two connectors are attached, with lugs of one connector located in the locking sections 130 of the other connector as described above with reference to FIG. 8. In order to separate the two connectors, a user rotates the connectors relative to one another about the attachment axis 6 such that the lugs travel transversely along the locking sections 130. When the lugs reach the intermediate portions 131 of the guideways 121, 122, 123, a portion of the rotational force is converted into axial force, helping to axially separate the two connectors as the lugs travel along the intermediate portions 131.

It will be appreciated that any suitable region of the guideways 121, 122, 123 may be angled so as to have both axial and circumferential components. It will also be appreciated that the intermediate portions 131 may be located on all or only some, or one, of the guideways 121, 122, 123.

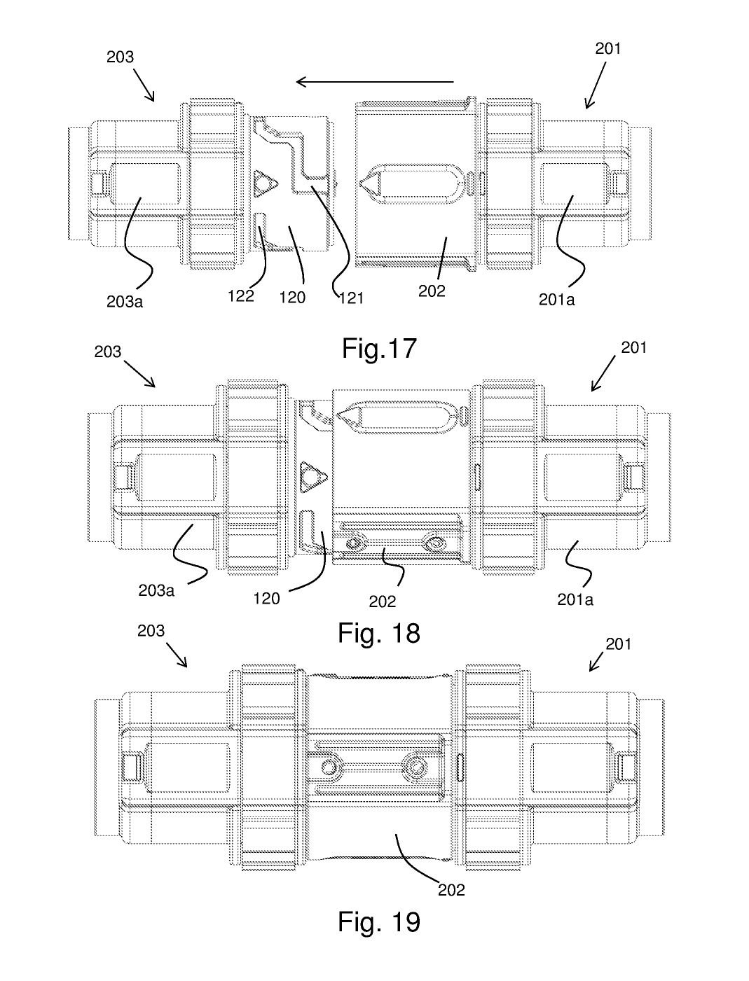

FIGS. 17 to 19 show two connectors in various stages of attachment, from being completely separated in FIG. 17 to locked together in FIG. 19.

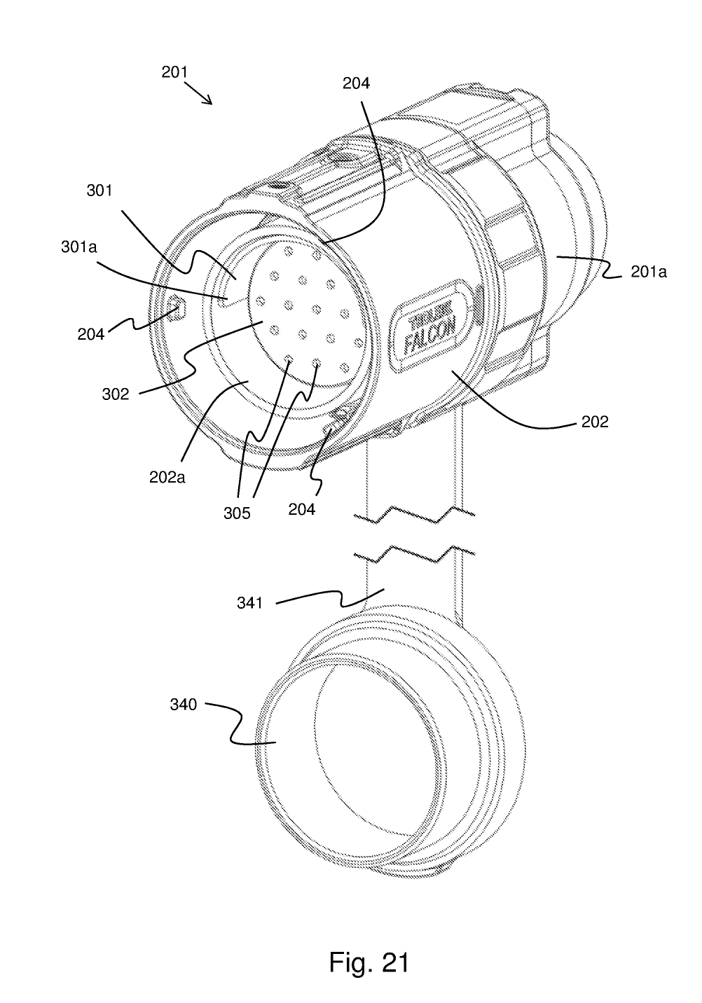

FIG. 18 shows a first connector 201 comprising an attachment portion 202 and a second connector 203 comprising the attachment portion 120 shown in FIG. 15. The first and second connectors 201, 203 may be the same as connectors 2, 4 described above, but with the attachment portions described with reference to FIG. 15. As with the attachment portion 38 described above, the attachment portion 202 shown in FIGS. 17 to 19 takes the form of a sleeve which is movable relative to a main body 201a of the connector 201, where lugs 204 (see FIG. 21) protrude radially inward from an inner circumference of the sleeve. The attachment portion 202 is mounted on a support portion 202a in a similar arrangement as described above with reference to FIG. 1. The attachment portion 202 differs from the attachment portion 38 shown in FIG. 4 in that the attachment portion 202 comprises three lugs 204, rather than two lugs, where the angular arrangement of the lugs 204 is configured so as to match the angular arrangement of the guideways 121, 122, 123 of the attachment portion 120, including the appropriate angular offset.

In FIG. 17 the two connectors 201, 203 are separated. In FIG. 18, the connectors 201, 203 have been brought together, such that the lugs 204 have travelled axially along the release section 127 of the guideways 121, 122, 123, and the attachment portion 202 has then been rotated such that the lugs 204 have travelled transversely along the intermediate section 128 of the guideways 121, 122, 123. As described above, at this stage the contacts (not shown in FIGS. 17 to 19) of each connector 201, 203 are not touching. In FIG. 19, the connectors 201, 203 are locked together, with the contacts of each connector 201, 203 touching, where the lugs have travelled axially along the disconnection section 129 of the guideways 121, 122, 123, and then the attachment portion 202 has been rotated such that the lugs have travelled transversely along the locking section 130 of the guideways 121, 122, 123.

The attachment portion 202 has a limited range of rotational movement. That is, the attachment portion 202 cannot rotate 360 degrees about the main body 201a. In an embodiment, the angle through which the attachment portion 202 can rotate through may be equal to the angle over which the intermediate section 128 extends, locking section 130 extends, or equal to a combination of both the angles through which the intermediate section 128 and locking section 130 extend. In an embodiment, the attachment portion 202 can rotate through about 45 degrees with respect to the main body 201a. Limiting the angle through which the attachment portion 202 can rotate ensures that the connectors 201, 203, can only be connected together in a single orientation. The limited range of rotational movement may be achieved by any suitable mechanical coupling between the attachment portion 202 and the support portion 202a. For example, a lug (such as projection 58 shown in FIG. 1) in one of the attachment portion 202 or support portion 202a may extend into a circumferential guideway (such as circumferential recess 60 as shown in FIG. 1) on the other of the attachment portion 202 or support portion 202a, where the length of the circumferential guideway covers the desired angle.

It will be appreciated that while one of the connectors has been described as having guideways, and the other having lugs configured to enter the guideways, both connectors could have a mixture of guideways and lugs.

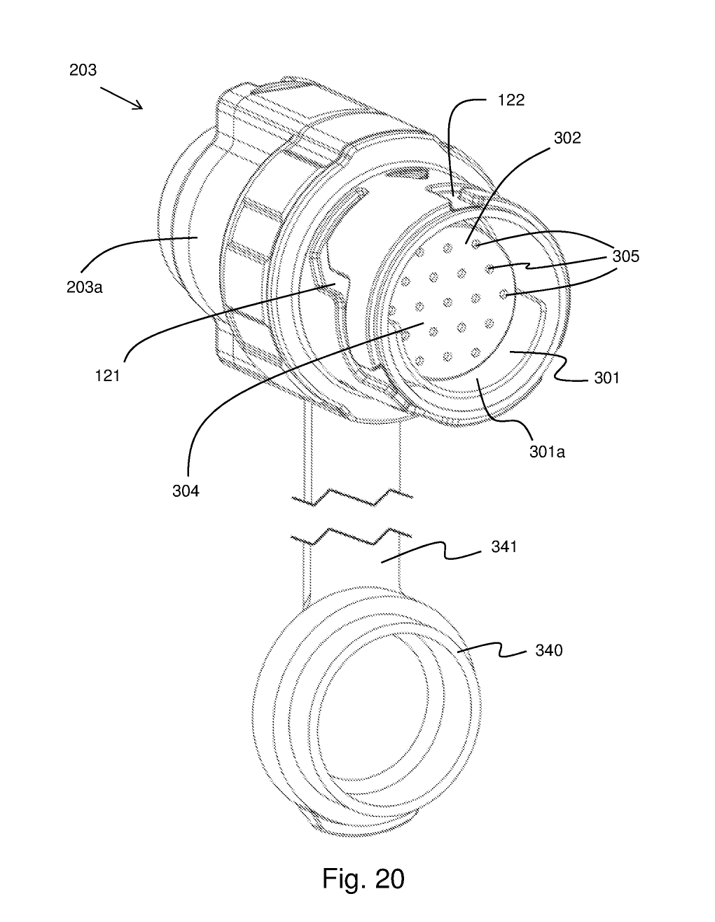

With reference to FIGS. 20 to 24, and FIG. 30, there is now described a coding mechanism for connectors. Coding (sometimes known as indexing) relates to setting a connector with a code, such that only connectors with a corresponding matching code can connect. Coding can be useful when many connectors are being used, particularly if the connectors themselves are otherwise identical. The coding mechanism of the present invention is arranged such that only a pair of connectors which have a corresponding coding (or indexing) can be attached. If the coding of two connectors does not correspond with one another, the connectors are prevented from being attached, and in particular, the contacts, such as electrical contacts, of the two connectors are prevented from making physical contact.

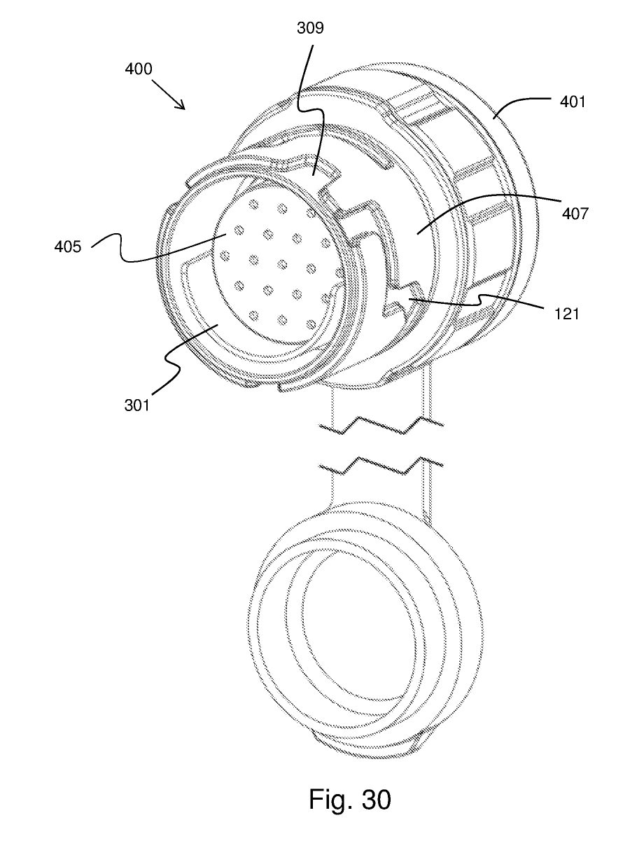

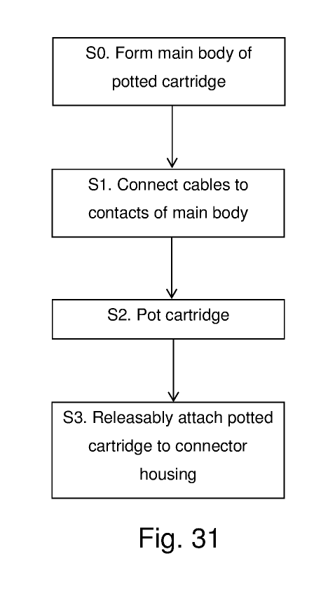

In an embodiment, the coding mechanism comprises first and second portions. The first portion is a coding collar 301, which is rotatable relative to contacts 305 and which has interlocking features configured to interlock with interlocking features of a coding collar on a second connector. The second portion comprises either a tooth (not shown) configured to enter a recess on the second connector, or a recess 309 (see FIG. 30) configured to receive a tooth on the second connector. The coding mechanism is configured such that both first and second portions must be correctly aligned in order for the connectors to mate, and more particularly, the contacts 305 to touch. The first and second portion of the coding mechanism each have a rotational symmetry of order one about the rotational axis 6.

Referring to FIGS. 20 and 21, there is shown a perspective view of the second connector 203 comprising the coding collar 301 and the first connector 201 comprising the coding collar 301 respectively. Both FIGS. 20 and 21 shows the connectors 201, 203 having female contacts 305, however it will be appreciated that the either one of the connectors 201, 203 may comprise male contacts to mate with the female contacts of the other connector. Both FIGS. 20 and 21 also show the connectors 201, 203 with a cap 340 which can be used to cover the exposed contacts when the connector is not in use. However, it will be appreciated that the cap 340 is not essential. The cap 340 is coupled to the connector 201, 203 via strap 341, where strap 341 is shown with a discontinuity marker indicating that the length of the strap may be longer than shown.

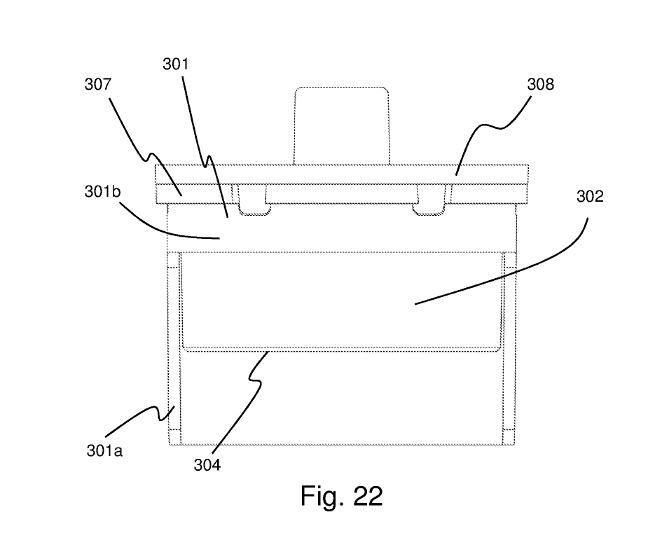

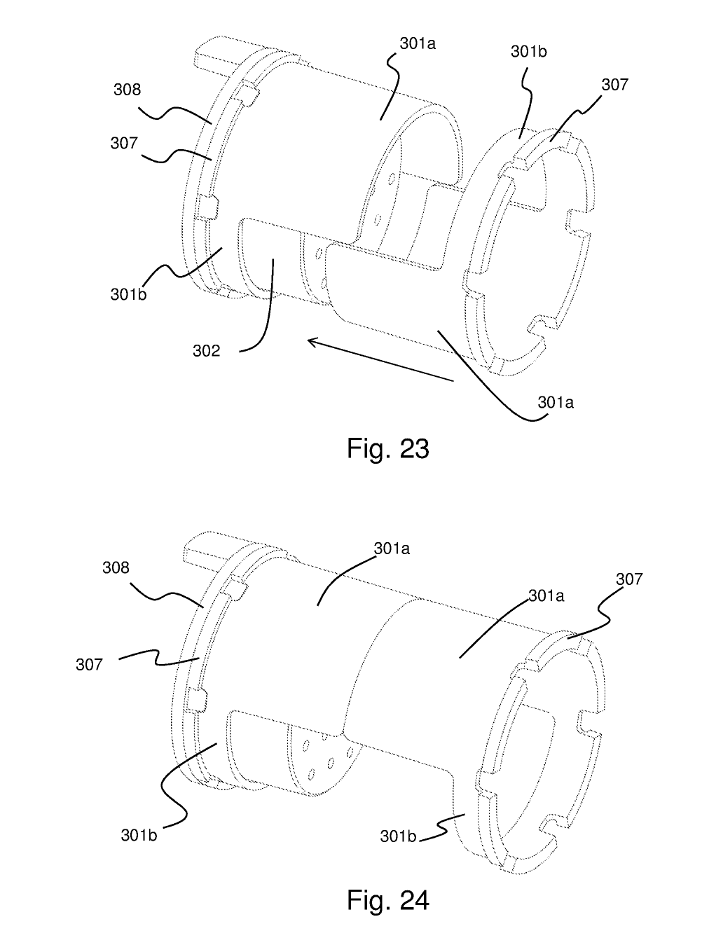

The connectors 201, 203 comprises an electrically insulating insert 302 as in the connectors 2, 3 described above, and which performs the same function as insert 24, 28 described above. The insert 302 may comprise a plastic material. The insert 302 comprises the contacts 305 and may further comprise a cover plate as described above. The coding collar 301 comprises an interlocking feature configured to interlock with a corresponding interlocking feature on a coding collar of another connector, allowing the connectors to connect, when the two coding collars have corresponding coding (in this case, corresponding relative orientation). In the example shown in FIGS. 20 to 24, the interlocking feature of the coding collar 301 comprises an extended portion 301a and a retracted portion 301b (shown more clearly in FIGS. 22 to 24). The retracted portion 301b is arranged to receive an extended portion of a second coding collar and the extended portion 301a is arranged to extend into a retracted portion of the second coding collar. In this way, a pair of coding collars can mate when in the correct relative rotational alignment as shown in FIG. 23, and are prevented from mating when not in the correct relative rotational alignment as shown in FIG. 24.

In the example shown, the extended portion 301a extends axially beyond a surface 304 of the insert 302 comprising the contacts 305 (in a direction pointing away from the connector 203 and towards to the second connector) and the retracted portion 301b extends axially behind the surface of the insert 302. However, it will be appreciated that this need not be the case. For example, the recessed portion may be flush with the surface 304 of the insert 302. In an embodiment, the extended portion 301a extends substantially the same distance beyond the surface 304 of the insert 302 as the distance the retracted portion 301b extends axially behind the surface 304.

The coding collar 301 is configured such that the coding collar's 301 orientation about the attachment axis 6 can be changed relative to the contacts 305. In an embodiment, the coding collar 301 is a separate component from the insert 302 containing the contacts 305 and so can be rotated separately from the insert 302. The coding collar 301 is also configured such that the coding collar's 301 orientation about the attachment axis 6 can be changed relative to the tooth/recess 309 of the connectors 201, 203.

It will be appreciated that the second portion, while described as a tooth/recess, may be any interlockable features which prevent rotation of the connectors relative to one another when the interlockable features interlock. For example, the second portion could be a screw hole through which a screw can pass so as to attach the connector to another connector.

Allowing the coding collar to rotate relative to the tooth/recess 309 provides an adjustable coding. That is, the coding is defined by the relative positions of the interlocking feature of the coding collar 301 and the tooth/recess 309. Allowing rotation of the coding collar 301 relative to the insert 302 allows the coding of the connector to be set without having to rotate the insert 302. Rotation of the insert 302 can lead to wires or cables, that are connected to the contacts 305 of the insert 302, becoming twisted and, in some cases, damaged.

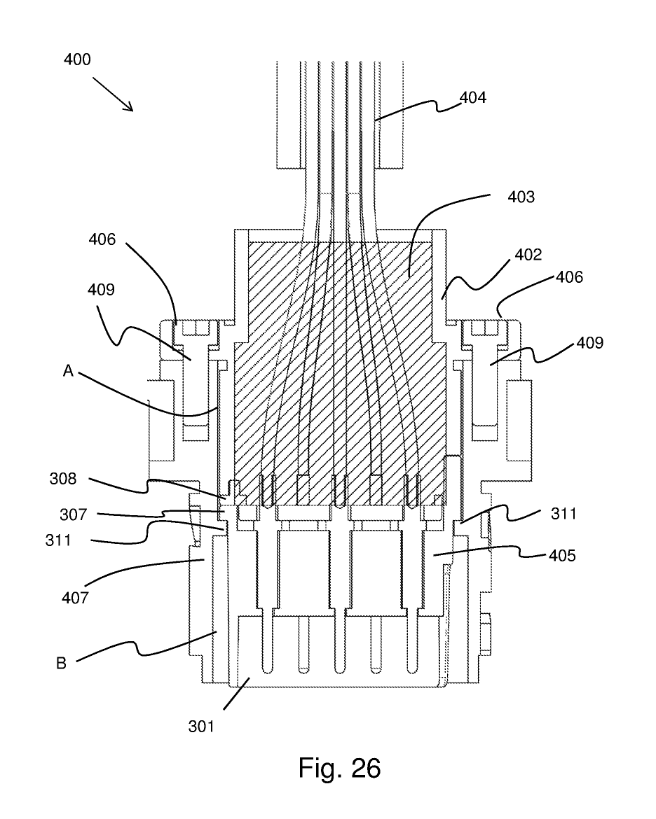

The coding collar 301 may be attached to a connector in which it is installed by any suitable means. For example, the coding collar 301 may be attached to the main body 201a, 203a by way of a clamping action between the main body 201a, 203a and the attachment portion 120, 202. For example, a user places the coding collar 301 between the main body 201a 203a in a desired orientation, and then attaches the attachment portion 202, 120 to the main body 201a, 203a via screws 409 (see FIG. 26), such that the coding collar 301 is clamped between the attachment portion 120, 202 and the main body 201a, 203a. In the embodiment shown, the coding collar 301 has a lip 307 which is configured to be clamped between a lip 308 on the insert 302 and a lip on the attachment portion (not shown). In the case of the connector 201 shown in FIG. 22, the collar 301 may be clamped between the main body 201a and the support portion 202a on which the attachment portion 202 is rotatably mounted.

The coding collar 301 may be mounted on the insert 302 (see FIGS. 22 to 23), where the insert 302 is fixed relative to the main body 201a, 203a, and clamped between the attachment portion 120 (or support portion) and the insert 302. However, it will be appreciated that the coding collar may be located at any suitable location within the connector 201, 203.

The clamping action prevents the coding collar 301 from any further rotation, fixing the coding of the connector. There may be a plurality of defined positions in which the coding collar can be rotated. For example, additional interlocking features may be present on both the coding collar 301 and the insert 302, where the additional interlocking features mate when the coding collar has one of a plurality of discrete orientations relative to the connector.

Alternatively, the coding collar 301 may be mounted to the main body 203a in such a way such that the torque required to turn the coding collar 301 to another discrete position is relatively large, such that the coding collar 301 will only rotate to another discrete position when sufficient torque is applied by a user. This may be achieved using a saw tooth track and a resiliently deformable pin, where the resiliently deformable pin is arranged on the collar and the saw tooth track is arranged on the main body 203a (or vice versa), and where the resiliently deformable pin is arranged to ride along the saw tooth track, with the discrete position corresponding to positions in which the resiliently deformable pin is located between two teeth. In such an embodiment, in order to rotate the collar to the next position, a user must supply sufficient torque such that the resultantly deformable pin rides up and over the saw tooth to reach the next position.

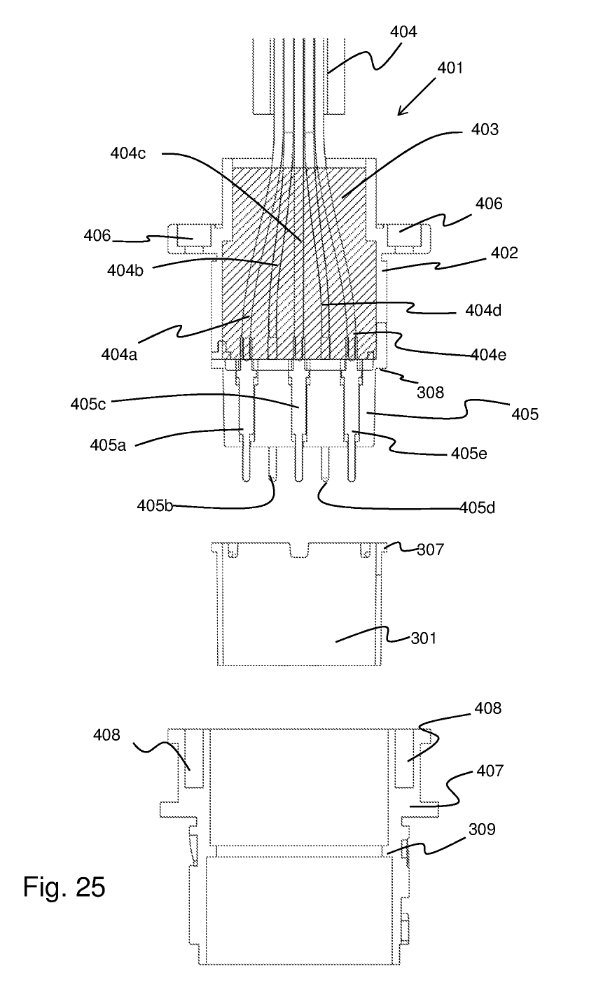

An illustration of a coding collar 301 mating with another coding collar 301 is shown in FIG. 24 (only one insert 302 is shown for clarity). The coding collars 301 are identical, and both collars 301 have extended portions 301a and recessed portion 301b. FIG. 25 illustrates an example where the two coding collars 301 do not have relative orientations which allow mating, such that the extended portions 301a abut before the contacts of the connectors can come into contact. Thus, two connectors which have not been coded to work with one another (e.g. do not have the correct relative orientation of their coding collars) are prevented from being connected by abutment of features of their coding collars.

In the embodiment shown, the extended portion 301a of the coding collar 301 spans 180 degrees and the recessed portion 301b of the coding collar 301 also spans 180 degrees. This allows multiple collars having the same design to be used on multiple connectors. However, it will be appreciated that the circumferences of the extended and recessed portions 301a, 301b may differ. For example, the extended portion of a first coding collar may span two thirds the circumference of the collar (i.e. 240 degrees), and a recessed portion may span one third the circumference of the collar (i.e. 120 degrees). The corresponding second coding collar configured to mate with the first coding collar will have an extended portion which spans one third the circumference of the collar (i.e. 120 degrees) so as to enter the recessed portion of the first collar, and a recessed portion which spans two thirds of the circumference of the second coding collar (i.e. 240 degrees) such that the extended portion of the first coding collar can enter the recessed portion of the second coding collar.

The coding mechanism can be selectively changed by a user such that the user can select their own coding for different connectors. For example, a user can set the coding for a pair of connectors by rotating one of the coding collars into a first orientation and the other coding collars into a second orientation which is 180 degrees from the first orientation. In this way, the two connectors can be attached as described above. Different pairs of connectors can use the same coding collars, but where each pair is rotated in a different orientation relative to the rest of the pairs such that only matching pairs can be attached to one another. This is advantageous as a user may have a large number of connectors, and so by selecting different coding for each pair of connectors, incorrect pairs cannot be attached.

The interlocking features of the coding collar, while providing a coding mechanism, also provide further stability to the connectors and help to reduce force experienced by one of the connectors being transfer to the male/female contacts 305.

While the coding collar 301 has been described as having an extended portion 301a and a recessed portion 301b, it will be appreciated that the interlocking features may take on any suitable form.

The coding mechanism described above may be used with a potted connector as described below.

In some implementations, it is desirable or necessary to pot a connector. For example, it can be advantageous to use a potted connector in hazardous environments, since potting the connector hermetically seals the connector and can protect wires of cables from corrosion. Potted connectors may be used when the connector is to be installed at a boundary between Ex d and non Ex d regions.

Unlike the connectors 2, 4, 201, 203 described above which may be supplied to a user as a kit of parts, potted connectors are supplied to a user in an assembled, potted, state. That is, the connector is assembled, a coding is set, and a potting material, such as an epoxy resin or thermoplastic resin is then poured into the entire connector and allowed to set, freezing the connector in a single configuration. However, potted connectors manufactured in this way suffer from a disadvantage in that a user must know the coding they require prior to manufacturing the potted connector, since once manufactured, the coding of a potted connector cannot be changed due to the potting material. Referring to FIGS. 25 to 28, there is described a connector 400 and method of manufacture of said connector 400 which helps mitigate or obviate the aforementioned problem.

FIG. 25 shows an exploded side view of the connector 400 which comprises a potted cartridge 401, the coding collar 301 described above, and a connector housing 407, where the potted cartridge 401, coding collar 301 and the connector housing 407 are shown as separated. The potted cartridge 401 comprises a main body 402 which defines a cavity 403 for the receipt of an end of a cable 404. In the example shown, the cable 404 is an electric cable and separates into five individual cables 404a, 404b, 404c, 404d, 404e, each of which connect to five electrical contacts 405a, 405b, 405c, 405d, 405e held in an electrically insulating insert 405 of the main body 402. The contacts shown in FIG. 25 comprises male pins, however it will be appreciated that the contacts may comprises female contacts. The cavity 403 is filled with an epoxy resin so as to encapsulate the cables 404a, 404b, 404c, 404d, 404e, holding the cables 404a, 404b, 404c, 404d, 404e in place relative to the main body 402. The epoxy resin is illustrated by the hatch pattern within the cavity 403.

The connector housing 407 comprises one or more mechanical features which facilitate mechanical connection to another connector. For example, with reference to the connectors 201, 203 described above, the connector housing 407 may comprise one of lugs or guideways 58, 121, 122, 123 (not shown in FIG. 25). The connector housing 407 may comprise the support portion 42, 202a described above, upon which a rotatable attachment portion, such as attachment portion 202 may be mounted. The connector housing 407 comprises connection means for allowing the cartridge 401 to be releasably attached to the connector housing 407. In the example shown in FIG. 25, the releasable attachable means are provided by two recesses 408 configured to receive screws.

Once the potted cartridge 401 has been potted, the potted cartridge 401 is attached to the connector housing 407, with the coding collar 301 located between the potted cartridge 401 and the connector hosing 407 such that the coding collar 301 is clamped between the cartridge 401 and the connector hosing 407. The connector housing comprises a lip 311 for engaging with the lip 307 of the collar 301 so as to clamp the coding collar 301 between the connector housing 407 and the lip of the insert 405.

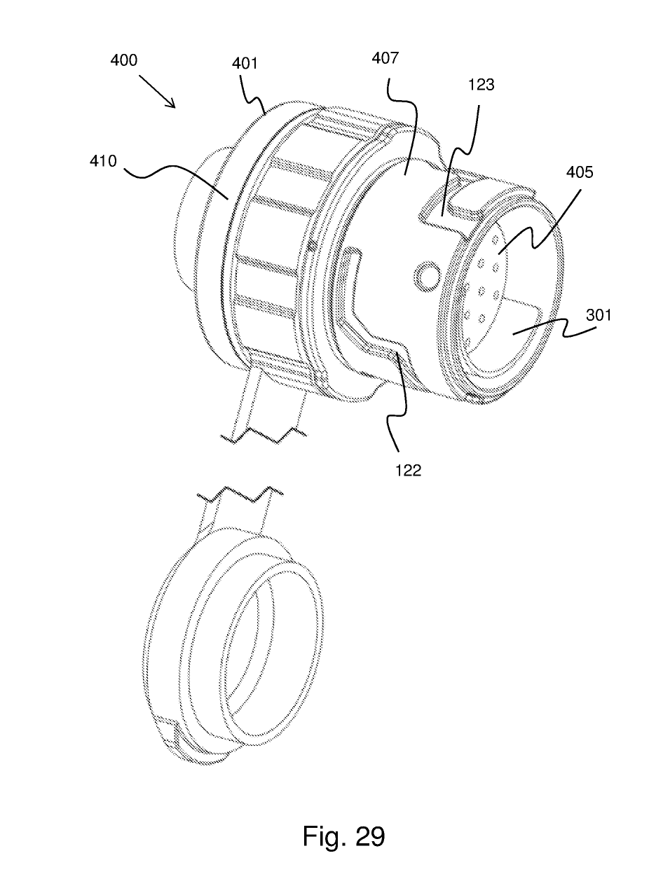

The potted cartridge 401 may be attached to the connector housing 407 during manufacture, or may be attached by an end user (e.g. the potted cartridge 401 may be provided to a user independently of the connector housing 407). In the example shown in FIGS. 29 and 30, the connector housing 407 comprises the guideways 121, 122, 123 described above. It will be appreciated that the connector housing 407 may instead comprise the lugs 204. As such, the connector housing 407 may perform the same function as the attachment portions 36, 38, 120, 202 described above. In the example shown, the potted cartridge 401 is attached to the connector housing 407 using screws 409 which attach through screw holes 406 in the main body 402 and recesses 408 on the connector housing 407. Using screws 409 allows the potted cartridge 401 and the connector housing 407 to be releasably attached or detached (e.g. by screwing the components together, or undoing the screws to allow the components to become separated). However, it will be appreciated that any suitable connection means which allows releasable attachment may be used.

While the coding collar 301 is shown in FIG. 25, it will be appreciated that in certain embodiments, the coding collar 301 may not be present.

FIG. 26 shows the connector 400 when the potted cartridge 401 and the connector housing 407 are attached to one another with screws 409, where the coding collar 301 is clamped between the potted cartridge 401 and the connector housing 407. While not shown, a cable gland may be used between the cable 404 and the main body 402. The connector 400 has two flame paths, A and B are shown in FIG. 26. Flame path A is co-operatively defined between an outer surface of the potted cartridge 401 and an inner surface of the connector housing 407. Flame path B is co-operatively defined between an inner surface of the connector housing 407 and an outer surface of a second connector housing when a pair of connectors are attached. Each flame path may be of a predetermined length which runs from the cavity to an external surface of at least one of the connectors. The predetermined length of one or both of the flame paths may conform to any appropriate standard, national or otherwise, such as the British Standard BS EN 60079-1 for example.

The flame path conforming to British Standard BS EN 60079-1 may prevent any explosion or fire occurring within the connectors from propagating to the environment surrounding the connectors. For example, by conforming to the above standard the flame path will be of sufficient length that any hot gases ejected along the flame path as a result of a fire or explosion within the connectors have cooled sufficiently by the time they exit the flame path that they are no longer hot enough to ignite any flammable or explosive material (for instance a flammable gas or fine powder) surrounding the connectors.

Where the connectors are of conventional size, the predetermined length of the flame path may be at least 10 mm. Alternatively or in addition, for the sake of compactness the flame path may be less than 30 mm, for instance less than 20 mm or less than 15 mm.

By potting the cartridge 401, rather than the entire connector, connector 400 is a potted connector which can be adjusted by the user following manufacture. For example, the coding of the connector 401 may be changed by removing the connector housing 407 and rotating the coding collar 301 into a different orientation before reattaching the connector housing 407 to the potted cartridge 401, allowing the connector 400 to be paired with another connector. Additionally, the potted cartridge 401, coding collar 301, or connector housing 407 may be replaced independently of the rest of the connector 400 when worn or damaged. Therefore, a connector 400 is provided which has the integrity of a traditional potted connector, but with improved flexibility.

Furthermore, as coding is not set during manufacture, each potted cartridge is identical (depending only on the socket arrangement) and so the manufacturing process is sped up, and potted connectors can be stockpiled ready for use. A further advantage of the potted cartridge 401 is that the potted cartridge can be manufactured without having to twist the cables while setting the coding. For example, in prior art methods the cables are connected to the contacts of the insert, and then the main body is rotated to a specific orientation relative to the connector housing to set a desired coding. Potting material is then added to the connector, freezing the connector. However, rotation of the main body when setting the coding causes the cables to become twisted about the attachment axis. Such twisting can damage the cables and the connection of the cables to the contacts.

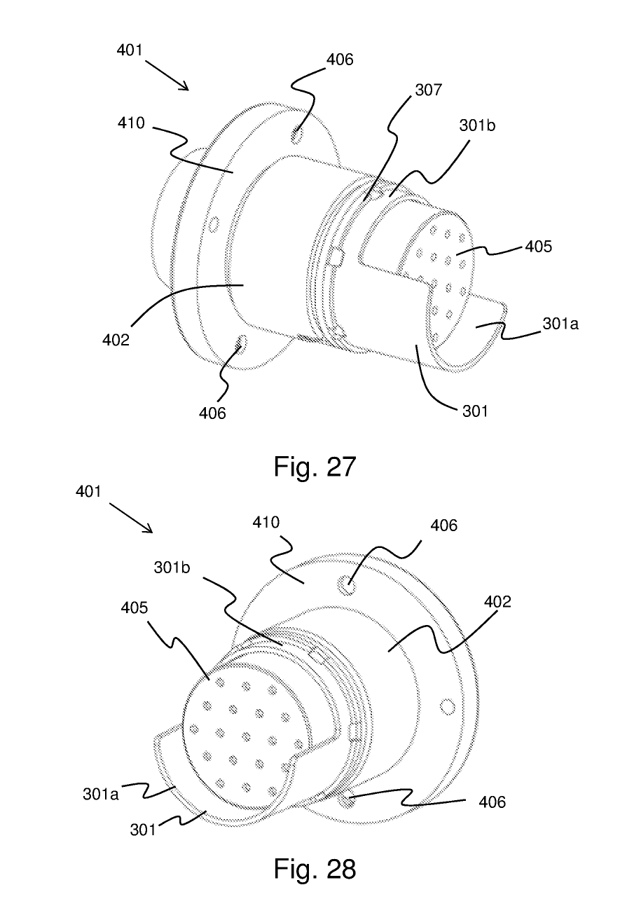

FIGS. 27 and 28 show perspective views of the potted cartridge 401 with coding collar 301, and comprising a backing ring 410. The backing ring 410 is located towards a rear end of the main body 402, the rear end being an end opposite an end containing the contacts 405. The radius of the backing ring 410 is larger than a radius of the portion of the main body comprising the contacts 405. The backing ring 410 is arranged to abut a surface of the connector housing 407 when the potted cartridge 401 is brought together with the connector housing 407. As shown, the backing ring 410 comprises the screw holes 406. FIGS. 29 to 30 show perspective views of the connector 400 when the potted cartridge 401 has been connected to the connector housing 407.

With reference to FIG. 30, there is described a method of manufacturing a potted cartridge (Steps S0 to S2) configured to be releasably attached to a connector housing to form a connector, and a method of manufacturing said connector (step S3).

At step S0, a main body comprising a cavity and one or more contacts is formed or otherwise obtained. The main body may be the same as the main body 402 shown in FIG. 25. The main body may be formed using a machining process, casting process, or a mixture of the two. The main body may be formed from a number of individual components.

At step S1, one or more cables are connected to one or more contacts respectively, where the one or more cables are arranged to extend through a portion of the cavity. The contacts may be formed in the main body, or main be formed in an insert which is attached to or formed within the main body.

At step S2, the portion of the cavity is filled with a potting material so as to encapsulate a portion of the one or more cables. The potting material may be an epoxy resin or any other suitable potting material. The potting material may be injected or poured into the cavity through any suitable opening in the cavity, such as an opening through which the cable enters the cavity.

At step S3 the potted cartridge is releasably attached to a connector housing to form the connector. The connector housing is formed or otherwise obtained, and may be formed using a machining process, casting process, or a mixture of the two. A coding mechanism, such as a coding collar, may be attached to the connector. For example, the coding collar may be clamped in place between the potted cartridge and connector housing.

One or more components of the connector may be manufactured using 3D printing. 3D printing can be particularly advantageous for producing low volume items, such as custom made components. For example, regarding an insert comprising sockets/pins, a manufacturer will typically have a range of standard moulds for making inserts having standard socket/pin layouts and standard socket/pin diameters. However, if it is required to produce an insert having a different socket/pin arrangement or diameter to one of the standard layouts, custom moulds will need to be made. This can be time consuming and costly. 3D printing of custom parts addresses this problem as 3D printing does not require a physical mould to be made.

In order to create a 3D printed component, an image file format, such as CAD, is created which contains a specification of the component to be printed. The image file format is sent to a 3D printer, where the 3D printer uses the data contained within the image file format to print the component. The printed component may comprise a plastic material. For example, in the example described above, a 3D printer may be used to print a plastic insert having a custom layout of the sockets/pins. The insert may then be connected to the main body of the connector to provide further customisation.

The described and illustrated embodiments are to be considered as illustrative and not restrictive in character, it being understood that only preferred embodiments have been shown and described and that all changes and modifications that come within the scope of the invention as defined in the claims are desired to be protected. For instance, the contacts may not be received in electrically insulating inserts, but may instead be provided with individual insulating coatings, and be received in an electrically conducting portion of their respective connectors.

Although the above embodiments have been described in relation to the contacts of the connectors carrying sufficient electrical loading for sparking to occur, the present invention is not limited in applicability to such circumstances. For instance, as noted above, in some countries connectors for carrying low voltage electrical signals (for instance USB or Ethernet data connectors) must often be explosion-proof since they are rarely certified as being intrinsically safe, even if there is no significant risk of them sparking. In such circumstances, the present invention may also be utilised. For instance, a set of male contacts may be replaced by a male USB connector (i.e. a USB ‘plug’) positioned within a suitably shaped insert, and a set of female contacts may be replaced by a female USB connector (i.e. a USB ‘socket’) positioned within a suitably shaped insert.

The above modification may use conventional (albeit ruggedly designed) USB connectors. This may enable easy identification of the USB data connectors in the case that there are multiple sets of connectors in proximity to one another, and may also reduce production costs by allowing more off-the-shelf components to be used. In other cases, however, the invention may be applied to low voltage electrical connectors such as USB connectors while using the same contacts as are used for high voltage applications. For example, a USB cable may be wired to contacts of the same form as described above, each data line of the USB connection being wired to a different pin. Furthermore, connectors according to the present invention may utilise contacts of non-conventional structure to carry conventional data signals. For example, connectors according to the present invention may utilise proprietary Ethernet connectors in place of conventional contacts when carrying an Ethernet data signal.

As also noted above, optical connectors are increasingly being required to be explosion proof, due to legal limits on the amount of optical power which can be exposed in hazardous environments such as those in which flammable and/or explosive materials may be present. For example, electrical contacts may be replaced with optical contacts configured to transmit an optical signal when they contact one another (in this case through their opposing flat front faces), each contact being in communication with an optical cable such as a fibre-optic cable. In this case, the optical contacts are of conventional design, and have an auxiliary biasing mechanism which biases the fronts of the contacts towards one another (when the connectors are in the first configuration) so as to hold them against one another and thereby maintain the integrity of an optical signal passing between them.

In the above arrangement, if sufficient optical power exits the contacts when they part from one another during movement of the connectors from the first configuration to the second configuration, any fire or explosion ignited by that optical power would be contained by the connectors in the same manner as described above. In short, force from the fire or explosion may push the connectors to the second configuration but would not move them from the second configuration towards the third configuration, and when in the second configuration the connectors provide a flame path of sufficient length that hot gas from any fire or explosion ignited by the contacts would have cooled to a safe level by time it reached the environment.

The invention may also be applied to more than one type of connection at once. For instance, an electrical machine may be coupled to an external control device through a single pair of connectors, that pair of connectors having contacts for the transmission of drive current to the machine, and also contacts for carrying a data signal from one or more feedback sensors positioned on the machine.

For completeness, it should be noted that the invention may even be used where the maximum power output from the contacts (whether electrical or optical) is certified as being intrinsically safe. As discussed above, explosion-proof connectors (such as those provided by the present invention) may be utilised at the boundary of an ‘Ex d’ enclosure so as to maintain the integrity thereof, even if the connectors themselves do not present an ignition/detonation risk.

It is to be understood that although sparking is described above as occurring when the connectors are at a particular intermediate point between the first and second configurations, it is to be understood that the exact position of the connectors at which a spark occurs may vary, depending on (for instance) the instantaneous voltage difference between the contacts of the connectors. Sparking may therefore potentially take place through a range of different connector positions and/or at different times (including the time at which the connectors reach the first configuration or the second configuration). The same applies in relation to ignition/detonation due to optical output from an optical contact.

In relation to the claims, it is intended that when words such as “a,” “an,” “at least one,” or “at least one portion” are used to preface a feature there is no intention to limit the claim to only one such feature unless specifically stated to the contrary in the claim. When the language “at least a portion” and/or “a portion” is used the item can include a portion and/or the entire item unless specifically stated to the contrary.

Optional and/or preferred features as set out herein may be used either individually or in combination with each other where appropriate and particularly in the combinations as set out in the accompanying claims. The optional and/or preferred features for each aspect of the invention are also applicable to any other aspects of the invention where appropriate.

1. A method of manufacturing a potted cartridge, the potted cartridge configured to be releasably attached to a connector housing to form a connector, the connector being for attachment to a second connector along an attachment axis, the method comprising:
connecting one or more cables to one or more contacts respectively, the one or more contacts being arranged within a main body of the potted cartridge, the main body comprising a cavity and the one or more cables extending through a portion of the cavity;
filing a portion of the cavity with a potting material so as to encapsulate a portion of the one or more cables.

2. The method of claim 1, further comprising forming, on the main body, a connection means configure to facilitate releasable attachment to the connector housing.

3. A method of manufacturing a connector, the method comprising
releasably attaching a potted cartridge to a connector housing to form a connector,
the connector being for attachment to a second connector along an attachment axis.

4. The method of claim 3, further comprising forming, on the connector housing, a connection means configured to facilitate releasable attachment to the potted cartridge.

5. The method of claim 3, further comprising attaching a coding mechanism to the connector, the coding mechanism configured to allow connection of two connectors having corresponding coding and prevent connection of two connectors having non-corresponding coding, a portion of the coding mechanism configured to be moveable relative to the one or more contacts so as to set a coding of the connector prior to connection to said second connector.

6. The method of claim 5, wherein the portion of the coding mechanism comprises a collar.

7. The method of claim 6, the method further comprising attaching the collar between the potted cartridge and the connector housing.

8. The method of claim 7, wherein attaching the collar between the potted cartridge and the connector housing comprises clamping the collar between the potted cartridge and the connector housing.

9. The method of claim 3, further comprising forming an attachment means on the connector housing, the attachment means configured to facilitate attachment to said second connector.

10. A potted cartridge for installation within a connector housing to form a connector, the connector being for attachment to a second connector along an attachment axis, the potted cartridge comprising;
a main body comprising an cavity;
one or more contacts arranged within the main body and configured to connect to one or more second contacts on said second connector;
one or more cables arranged within the cavity and connected to the one or more contacts;
a potting material arranged within the cavity of the main body;
wherein the potted cartridge is configured to be releasably attached to said connector housing.

11-18. (canceled)
